(19) United States
(12) Patent Application Publication
(10) Pub. No.: US 2025/0267216 A1
(43) Pub. Date: Aug. 21, 2025

(54) SYSTEM AND METHOD FOR MANAGING INTERACTION TRANSCRIPTS

(71) Applicant: NICE LTD., Ra'anana (IL)

(72) Inventors: Seemit Vijay SHAH, Pune (IN); Salil DHAWAN, Pune (IN); Darshan AMBHAIKAR, Pune (IN)

(73) Assignee: NICE LTD., Ra'anana (IL)

(21) Appl. No.: 18/444,821

(22) Filed: Feb. 19, 2024

(51) Int. Cl. H04M 3/51; H04M 3/523

(52) U.S. Cl. CPC H04M 3/5175; H04M 3/5232

(57) ABSTRACT

A system and method for managing interaction transcripts based on rules may include a computing device; a memory; and a processor, the processor configured to: identify one or more decision parameters in an interaction transcript; determine at least one decision category for a rule from the one or more decision parameters; calculate probabilities for the at least one decision category for the rule using the one or more decision parameters; and apply the rule by selecting one or more action categories for the interaction transcript based on the calculated probabilities for the at least one decision category.

### TECHNICAL FIELD OF THE INVENTION

The present invention relates generally to the management of transcripts, specifically to the automatic generation of rules for the handling of interaction transcripts.

### BACKGROUND OF THE INVENTION

Interaction lifecycle management may involve overseeing various types of interactions, for example call and video recordings, chat transcripts, emails, email attachments, digital media chats, log files, images, etc., which are commonly generated and recorded for example within a contact center.

As part of the conduction of interactions, e.g. between customers an agents, organizations such as contact centers generate a high number of interaction recordings per day. The recording of interaction transcripts may result in considerable expenses for the access, storage, and retrieval of interaction recordings. To manage interaction data, e.g. data generated in the recording of interactions, interaction lifecycle management (ILM) may be used.

ILM can be used, for example to execute pre-set policies that govern the management of the computer data of interaction transcripts through various stages, e.g. retention, archival, deletion, transfer, copy, and/or relocation of interaction transcripts.

Existing approaches for ILM may rely on static rules. For example, customers can set lifecycle rules for actions such as archiving, deletion, and file copying of recorded interaction data. Following this setup, all future interactions are processed according to these pre-set rules.

However, the use of static, pre-set rules in the management of interaction transcripts may not allow for the assignment of dynamic rules for interaction recordings that may require a plurality of rules to manage data present in such interactions. For example, the generation of static rules for managing an interaction recording may not allow subsequent amendments to a static rule based on the introduction of additional rules or following amendment of rules as a result, e.g. handling of interaction transcripts for a case in which a customer follows up on a first interaction and provides additional information to a customer issue in response to a first interaction.

Thus, there is a need for a solution that allows for automatically managing interaction transcripts recorded in contact centers which is based on dynamically processing interaction recordings, e.g. interactions between contact center agents and customers.

### SUMMARY OF THE INVENTION

Improvements and advantages of embodiments of the invention may include automatically generating lifecycle rules for managing interaction recordings from interaction data items that are present in interaction recordings.

Improvements and advantages of embodiments of the invention may include making real-time decisions concerning the lifecycle of interactions using machine learning. Improvements and advantages of embodiments of the invention may include generating individual rules for managing interaction transcripts that are based on content in the interaction transcript. Improvements and advantages of embodiments of the invention may further include automatically implementing, reviewing and updating rules for the management of interaction recordings using machine learning. Improvements and advantages of embodiments of the invention may include automatically providing suggestions for the management of interaction transcripts to a user. Improvements and advantages of embodiments of the invention may include automatically managing interaction transcripts according to regulatory compliance, e.g. by automatically identifying requirements for managing a recorded interaction transcript, e.g. by ensuring interactions are retained or deleted in compliance with various regulations (such as General Data Protection Regulation (GDPR)). For example, embodiments of the invention may allow automatically selecting lifecycle policies for a given interaction.

One embodiment may include a method of managing interaction transcripts based on rules, the method including: identifying one or more decision parameters in an interaction transcript; calculating probabilities for the at least one decision category for the rule using the one or more decision parameters; and applying the rule by selecting one or more action categories for the interaction transcript based on the calculated probabilities for the at least one decision category.

In one embodiment, when the selection of the one or more action categories is based on a single-level selection, the rule is based on the decision category with the highest probability.

In one embodiment, when the selection of the one or more action categories is based on a multi-level selection, the rule is based on the at least one decision category whose calculated probabilities lie above a pre-set threshold value.

In an embodiment, the identified one or more decision parameters are normalized.

One embodiment includes encoding the identified one or more decision parameters into a numerical format.

In an embodiment, the one or more action categories are selected from one or more of: a retention decision, a deletion decision, a copy decision or a combination thereof.

In one embodiment, when the selected action category is a retention action, calculating a retention period and storing the interaction transcript for the retention period.

In one embodiment, when the selected action category is a deletion action, calculating a deletion period and storing the interaction transcript until expiry of the deletion period.

In one embodiment, when the selected action category is a copy action, calculating a copy period and copying the interaction transcript after expiry of the copy period.

In one embodiment, the one or more decision parameters are converted into binary vectors.

In one embodiment, applying the rule includes automatically generating rule recommendations using machine learning for managing the interaction transcript.

In one embodiment, the generated rule recommendations for managing the interaction transcript are automatically applied to the interaction transcript.

In one embodiment, the selected one or more action categories within the applied rule are periodically updated using machine learning.

One embodiment may include a system for managing interaction transcripts based on dynamic rules, the system including: a computing device; a memory; and a processor, the processor configured to: identify one or more decision parameters in an interaction transcript; determine at least one decision category for a rule from the one or more decision parameters; calculate probabilities for the at least one decision category for the rule using the one or more decision parameters; and apply the rule by selecting one or more action categories for the interaction transcript based on the calculated probabilities for the at least one decision category.

One embodiment may include for handling interaction recordings, wherein the method includes: identifying one or more interaction metadata items in an interaction recording; determining one or more decision categories for a rule from the one or more interaction metadata items; calculating probability values for the one or more decision categories using the one or more interaction metadata items; and applying the rule by selecting one or more handling categories for the interaction recording based on the calculated probability values for the one or more decision categories.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device which may be used with embodiments of the present invention.

FIG. 2 is a schematic drawing of a system for managing interaction transcripts, according to some embodiments of the invention.

FIG. 3A illustrates an exemplary system of components for lifecycle management, according to some embodiments of the invention.

FIG. 3B illustrates an exemplary system of components for lifecycle management, according to some embodiments of the invention.

FIG. 4 illustrates operations in the retrieval of decision parameters from interaction transcripts, according to some embodiments of the invention.

FIG. 5 depicts a flowchart of methods of managing interaction transcripts based on dynamic rules, according to some embodiments of the present invention.

FIG. 6 is a flowchart illustrating the processing of interaction transcripts in the generation rules for managing interaction transcripts, according to some embodiments of the present invention.

FIG. 7 provides an overview of operations in the processing of interaction transcripts to generate rules for the management of interaction transcripts, according to some embodiments of the present invention.

FIG. 8 illustrates operations in the pre-processing of decision parameters, according to some embodiments of the present invention.

FIG. 9 depicts a flowchart that illustrates operations in the selection of one or more action categories for an interaction transcript, according to some embodiments of the present invention.

FIG. 10 depicts a flowchart illustrating a selection of a retention action as an action category for a rule based on calculated probabilities for four decision categories, according to some embodiments of the present invention.

FIG. 11 depicts a flowchart that illustrates a selection of a deletion action as an action category for a rule based on calculated probabilities for two decision categories, according to some embodiments of the present invention.

FIG. 12 depicts a flowchart that illustrates a selection of a copy action as an action category for a rule based on calculated probabilities for two decision categories, according to some embodiments of the present invention.

FIG. 13 depicts a flowchart that illustrates operations in the application of a rule to an interaction, according to some embodiments of the present invention.

FIG. 14 depicts diagram that illustrates operations in the processing of interaction transcripts in the selection of rules for managing such interaction transcripts, according to some embodiments of the present invention.

FIG. 15 depicts an example user interface for managing interaction transcripts based on dynamic rules, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

As used herein, “contact center” may refer to a centralized office used for receiving or transmitting a large volume of enquiries, communications, or interactions. The enquiries, communications, or interactions may utilize telephone calls, emails, message chats, SMS (short message service) messages, etc. A contact center may, for example, be operated by a company to administer incoming product or service support or information enquiries from customers/consumers. The company may be a contact-center-as-a-service (CCaaS) company.

As used herein, “call center” may refer to a contact center that primarily handles telephone calls rather than other types of enquiries, communications, or interactions. Any reference to a contact center herein should be taken to be applicable to a call center, and vice versa.

As used herein, “interaction” may refer to a communication between two or more people (e.g., in the context of a contact center, an agent and a customer), typically via devices such as computers, customer devices, agent devices, etc., and may include, for example, voice telephone calls, conference calls, video recordings, face-to-face interactions (e.g., as recorded by a microphone or video camera), emails, web chats, SMS messages, etc. An interaction may be recorded to generate an “interaction recording”. An interaction recording may also refer to the data which is transferred and stored in a computer system recording the interaction, the data representing the interaction, including for example voice or video recordings, data items describing the interaction or the parties, a text-based transcript of the interaction, etc. Interactions as described herein may be “computer-based interactions”, e.g., one or more voice telephone calls, conference calls, video recordings/streams of an interaction, face-to-face interactions (or recordings thereof), emails, web chats, SMS messages, etc. Interactions may be computer-based if, for example, the interaction has associated data or metadata items stored or processed on a computer, the interaction is tracked or facilitated by a server, the interaction is recorded on a computer, data is extracted from the interaction, etc. Some computer-based interactions may take place via the internet, such as some emails and web chats, whereas some computer-based interactions may take place via other networks, such as some telephone calls and SMS messages. An interaction may take place using text data, e.g., email, web chat, SMS, etc., or an interaction may not be text-based, e.g., voice telephone calls. Non-text-based interactions may be converted into text-based interaction recordings (e.g., using automatic speech recognition). Interaction data and Interaction recordings may be produced, transferred, received, etc., asynchronously.

As used herein, “agent” may refer to a contact center employee that answers incoming interactions, and may, for example, handle customer requests.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms. In a supervised ML approach, input sample data may include data which is labeled, for example, in the present application, the input sample data may include a transcript of an interaction and a label indicating whether or not the interaction was satisfactory. In an unsupervised ML approach, the input sample data may not include any labels, for example, in the present application, the input sample data may include interaction transcripts only.

ML models may, for example, include (artificial) neural networks (NN), decision trees, regression analysis, Bayesian networks, Gaussian networks, genetic processes, etc. Additionally or alternatively, ensemble learning methods may be used which may use multiple/modified learning algorithms, for example, to enhance performance. Ensemble methods, may, for example, include “Random forest” methods or “XGBoost” methods.

Neural networks (NN) (or connectionist systems) are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

In practice, a NN, or NN learning, can be simulated by one or more computing nodes or cores, such as generic central processing units (CPUs, e.g., as embodied in personal computers) or graphics processing units (GPUs such as provided by Nvidia Corporation), which can be connected by a data network. A NN can be modelled as an abstract mathematical object and translated physically to CPU or GPU as for example a sequence of matrix operations where entries in the matrix represent neurons (e.g., artificial neurons connected by edges or links) and matrix functions represent functions of the NN.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores.

It will be understood that any subsequent reference to “machine learning”, “machine learning algorithms”, “machine learning models”, “ML”, or similar, may refer to any/all of the above ML examples, as well as any other ML models and methods as may be considered appropriate.

Lifecycle management includes components of lifecycle rules, such as:

A rule action may specify an action such as archive, delete, keep forever etc. for an interaction recording.

A rule, e.g. a rule criteria such as an action category, may be based on interaction metadata that can be derived from interaction recordings, e.g. agent identifier (ID), dialed number Identification service (DNIS, a service offered by a telecom provider to their customers letting them know what number was dialed for an incoming call), a phone number associated with a caller (ANI), skill, campaign, team etc..

A time for performing an action for an interaction recording may specify a duration after which an action needs to be performed, e.g. 10 days, 30 days, 365 days etc.. For example, a lifecycle rule may read: ARCHIVE all “Call Recordings” where “Agent is John Smith” After “90 Days”.

Customers may create multiple lifecycle rules with different priorities like P1, P2 . . . Pn. When an interaction fulfills more than one rule, e.g. more than one rule criteria, it may be processed according to the highest priority rule (single-level selection).

Problems that can be associated with interaction lifecycle management may include:

Limitations on a rule quantity: Restrictions on the number of lifecycle rules for an interaction transcript may prevent efficient management of interaction recordings. For example, users, e.g. agents of a contact center may be prevented from adequately covering all issues that have been raised in a customer-agent interaction, e.g. leading to potential gaps in the interaction lifecycle management.

Interdependency and conflict issues: In case that an interaction qualifies for multiple lifecycle rules, defining an order for the application of static rules or prioritizing a first lifecycle rule over a second lifecycle rule may lead to confusion and complexity since it may be unclear which rule should be executed first. Thus, errors or inconsistencies may arise in the handling of interactions transcripts with multiple lifecycle rules.

Rising complexity with increased interactions: A large number of recorded interaction transcripts may lead to the occurrence of a higher number of variables for managing interaction transcripts and can lead to limitations in the system's capacity to process and manage interactions efficiently.

Manual oversight concerns: Heavy reliance on manual processes for lifecycle governance can lead to human errors, inefficiency, and increased risks. Manual oversight might involve setting rules, monitoring interactions, and making decisions about archiving or deletion. This approach is not only labor-intensive but can also lead to inconsistency and mistakes in the handling of interaction recordings.

Retention duration issues: Identifying an appropriate duration to retain data recorded for an interaction can be complex, e.g. in cases when an interaction recording includes status enquiries, e.g. follow ups by an agent or customer. If data is kept for too long, it can increased storage costs and potential security risks. However, limitations in the retention of data may result in the loss of crucial information, which could be important for compliance, customer service, or analysis purposes.

Lack of context consideration: Static rules for managing interaction may fail to consider context of an interaction. Context, e.g. in form of previously recorded interaction transcripts, may be important for providing accurate feedback to a customer by taking into account special circumstances under which a customer attempts to re-engage with a contact center. For example, in case that a customer was provided with solution A to a customer issue in a first agent-customer interaction, recording of the first interaction transcript may ensure that the customer is provided with an alternative solution B in case that they could not solve a customer issue using initial solution A.

Regular changes in the management of interaction transcripts recorded in a contact center, e.g. updates in teams or agents may require frequent adjustments to lifecycle rules. For example, introducing of a new subgroup of agents for handling a new customer request, e.g. providing customer support for new product X may require a contact center to filter interaction transcripts for interactions that include product X. Adjustment of static lifecycle rules may thus require manually updating and monitoring static rules to ensure that they enable an efficient processing of updated rules in the processing of interaction transcripts.

Inflexibility Issues: Static lifecycle rules for interaction recordings may lead to a reduced flexibility in the handling of interaction transcripts, e.g. due to predetermined and immutable rules. In a dynamic environment like a contact center, conditions and requirements, e.g. for the retention or deletion of interaction transcripts can change rapidly. A system relying on static lifecycle rules may not be able to adapt to dynamic changes in the handling of interaction recording and, thus, may not respond effectively to new scenarios or unexpected challenges.

Inefficient use of storage resources: Static rules can give rise to inefficient data storage, e.g. by retaining irrelevant interaction transcripts or premature deletion of interaction recordings. This inefficiency can lead to increased storage costs for interaction transcripts or a reduced effectiveness in the data management of a contact center.

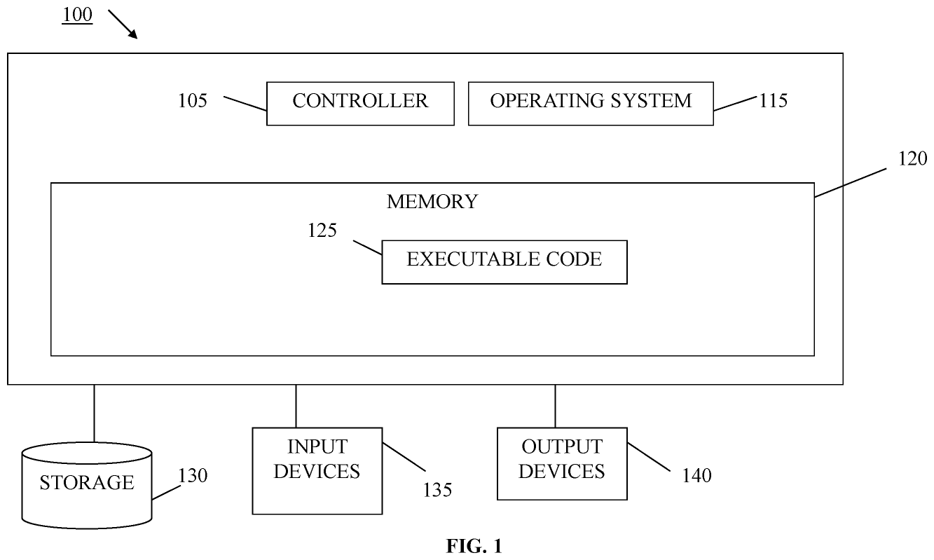

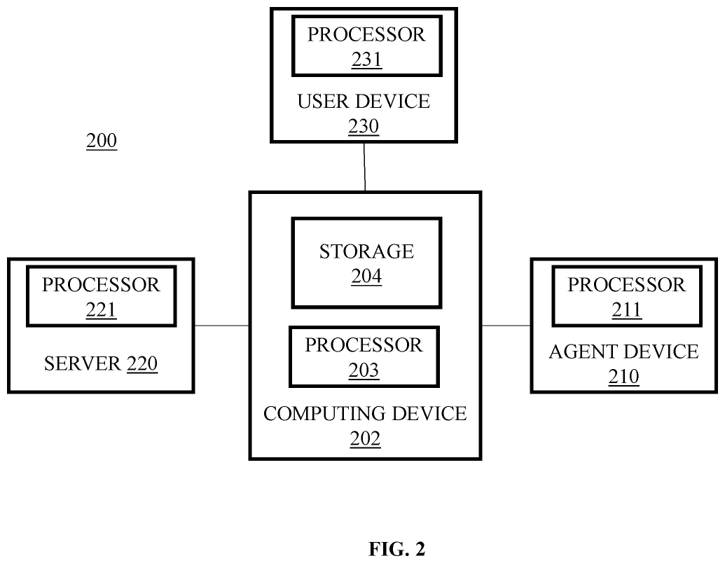

FIG. 1 shows a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of modules and equipment and other devices and modules discussed herein, e.g. computing device 202, agent device 210, customer device 220, user device 230, a dynamic interaction management service 312, a recommendation service 314, a continuous improvement and feedback service 310, a recording application 302, an interaction lifecycle management service 322 and modules in FIGS. 2, 3, 4, 5, 6, 7, 8, 9, 10, 11, 12, 13, 14 may be or include, or may be executed by, a computing device such as included in FIG. 1 although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data.

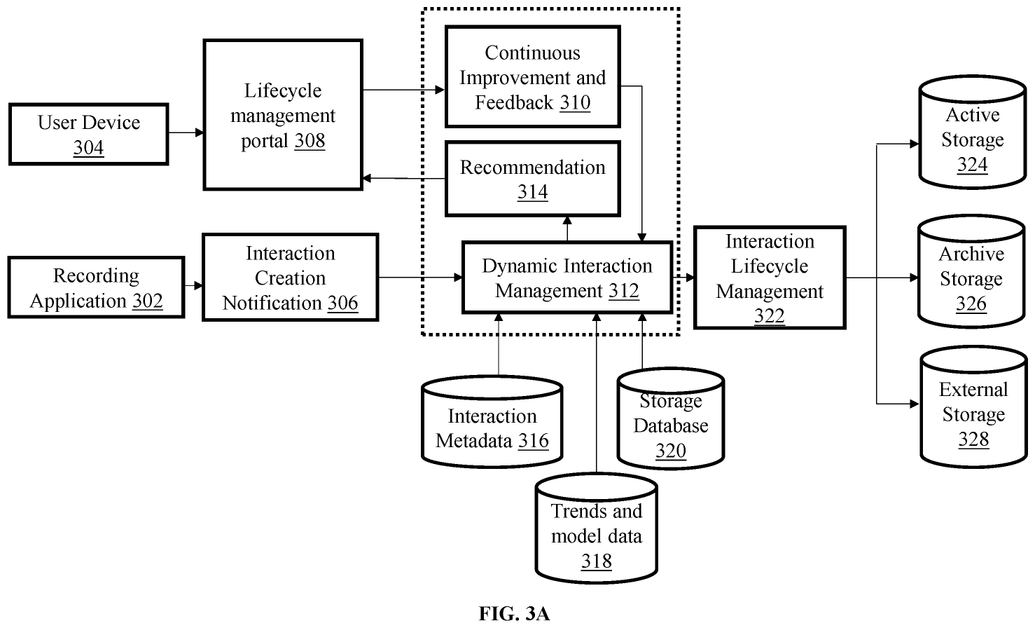

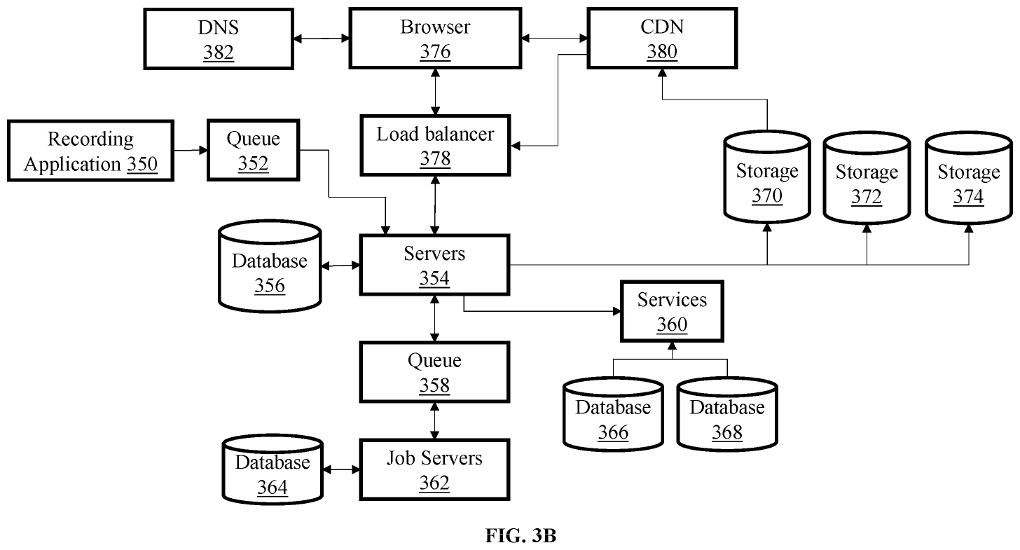

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIG. 3A according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by, for example, executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

FIG. 2 is a schematic drawing of a system 200 according to some embodiments of the invention. System 200 may include a computing device 202 including a processor 203 and storage 204. Computing agent device 202 may be connected to an agent device 210 that includes processor 211. Computing device 202 may be connected to a server 220 including processor 221. Computing device 202 may be connected to a user device 230 including processor 231. Server 220 and Agent device 210 may provide computing device 202 with interaction recordings. Alternatively, interaction recordings may be stored in storage 204 of computing device 202.

Computing devices 100, 202, 210, 220 and 230 may be servers, personal computers, desktop computers, mobile computers, laptop computers, and notebook computers or any other suitable device such as a cellular telephone, personal digital assistant (PDA), video game console, etc., and may include wired or wireless connections or modems. Computing devices 100, 202, 210, 220 and 230 may include one or more input devices, for receiving input from a user (e.g., via a pointing device, click-wheel or mouse, keys, touch screen, recorder/microphone, or other input components). Computers 100, 202, 210, 220 and 230 may include one or more output devices (e.g., a monitor, screen, or speaker) for displaying or conveying data to a user.

Any computing devices of FIGS. 1 and 2 (e.g., 100, 202, 210, 220 and 230), or their constituent parts, may be configured to carry out any of the methods of the present invention. Any computing devices of FIGS. 1 and 2, or their constituent parts, may include a dynamic interaction management service 312, a recommendation service 314, a continuous improvement and feedback service 310, a recording application 302, an interaction lifecycle management service 322, or another engine or module, which may be configured to perform some or all of the methods of the present invention. Systems and methods of the present invention may be incorporated into or form part of a larger platform or a system/ecosystem, such as agent management platforms. The platform, system, or ecosystem may be run using the computing devices of FIGS. 1 and 2, or their constituent parts. For example, a processor such as processor 203 of computing device 202 processor 211 of device 210, and/or processor 221 of computing device 220 may be configured to identify one or more decision parameters in an interaction transcript such as interaction sentiments, e.g. a sentiment score or interaction sensitivity. A processor such as processor 203 of computing device 202 processor 211 of device 210, and/or processor 221 of computing device 220 may be configured to determine at least one decision category for a rule from one or more decision parameters. For example, a processor such as processor 203, 211 and/or 221 may be configured to determine one or more decision categories for a rule from the one or more interaction metadata items, e.g. decision categories such as retention, copy deletion. A processor such as processor 203 of computing device 202 processor 211 of device 210, and/or processor 221 of computing device 220 may be configured to calculate probabilities for the at least one decision category for the rule using the one or more decision parameters. For example, for an interaction transcript X, probability values may be calculated for decision categories such as copy, retention and deletion. The probability values for the decision categories can be derived from decision parameters identified in an interaction transcript. A processor such as processor 203 of computing device 202 processor 211 of device 210, and/or processor 221 of computing device 220 may be configured to apply a rule by selecting one or more action categories for an interaction transcript based on calculated probabilities for at least one decision category. For example, a processor such as processor 203, 211 and/or 221 may be configured to apply a rule by selecting one or more handling categories for an interaction recording based on calculated probability values for the one or more decision categories. A handling category may be a category that includes a possible way of managing an interaction recording, e.g. creating a copy of an interaction on a server. For example, a selection of the one or more handling categories or action categories can be based on a single-level selection: the selection of one action category, e.g. copy action category that has the highest probability of all calculated probabilities for an interaction transcript or the selection of one or more action categories, e.g. a copy action and a deletion action category that have probability values that lie above a pre-set threshold, e.g. 30% probability. The term “based on” may include that a rule includes one or more action categories (such as store, copy, delete), when it is based on one or more action categories. For example, when a rule is based on a decision category with the highest probability (for a single-level decision), a rule may include as a decision category with the highest probability as an action category, e.g. a rule may include a condition or action such as “store the interaction for 4 months in internal storage”. For example, when a rule is based on decision category with probabilities that lie above a pre-set threshold (for a multi-level decision), a rule may include one or more decision categories that lie above a pre-set threshold as an action category, e.g. a rule may include a conditions or actions such as “store the interaction for 4 months in external storage” and “deleting the interaction after 4 months in external storage”. A processor such as processor 203 of computing device 202 may be configured to receive interaction recordings, e.g. interaction transcripts, that are stored, e.g. in storage of a user device 230, an agent device 210 or server 220. A processor such as processor 203 of computing device 202 may be configured to record interactions, e.g. phone calls, text chats, etc., to generate interaction recordings, e.g. interaction transcripts. User device 230 may be a computing device, e.g. computing device 100, that is used by a user such as a supervisor of an agent or an evaluator of an agent of a contact center. For example, agent X using agent device 210 may be in a text-based chat with customer Y. Processor 211 of agent device 210 may execute an interaction recording service that records the interaction between agent X and customer Y. When the interaction ends, an interaction recording between agent X and customer Y may be stored, e.g. in storage of agent device 210 or may be sent to storage 204 of computing device 202. A processor such as processor 203 of computing device 202 may be configured to manage interaction transcripts based on a rule, for example by applying a rule for an interaction transcript, e.g. a processor may execute an action category present in a rule. For example when a rule includes a copy action category such as “copy interaction transcript X to archive Z and store interaction transcript X for 3 months”, a processor such as processor 203 of computing device 202 may prompt database 204 to send interaction transcript X from storage Y to archive Z.

FIG. 3A illustrates an exemplary system of components for lifecycle management that may be required, e.g. for a contact center solution. Computing devices 100, 202, 210, 220 or 230 of FIGS. 1 and 2 or their constituent parts, may be configured to carry out any of the methods of the present invention. Any computing devices of FIGS. 1 and 2 or their constituent parts, may include a recording application 302, recommendation service 314, interaction lifecycle management application 322, servers such as storage 324, 326 and 328, or another engine or module, which may be configured to perform some or all of the methods of the present invention. A systems and methods of the present invention may be incorporated into or form part of a larger platform or a system/ecosystem, such as agent management platforms. The platform, system, or ecosystem may be run using the computing devices of FIGS. 1, 2, or their constituent parts.

A recording application 302 of a contact center may be a service that is responsible for the generation, storage, and management of interaction recordings, e.g. the recording of audio or video packets which are sent, for example, over Session Initiation protocol (SIP) to Web Real-Time Communications (WebRTC)/Real-time Transport protocol (RTP) during agent and customer interaction. A final recorded media file and transcript, e.g. interaction, metadata and transcript 304 include voice calls, video calls, emails, chat sessions, and social media communications.

A user, e.g. using a user computing device 230 or 304, may be an individual or entity that can interact with or utilize a lifecycle management portal to manage the interaction lifecycle as well as to monitor and administrator the system. For example, a user can be an administrator, a contact center agent, a supervisor of contact center agent or any entity with adequate permissions to interact with the system.

An interaction can be any form of communication between a customer and a contact center, such as a phone call, email, chat message, or social media contact, and the data recording this communication. Upon the creation of a new interaction, a recording system can generate a notification. A notification, e.g. interaction creation notification 306, can be a signal or alert intended to inform the systems about a new interaction recording. It serves as a prompt for further action. An interaction creation notification queue receives the notification and manages the flow of interactions efficiently.

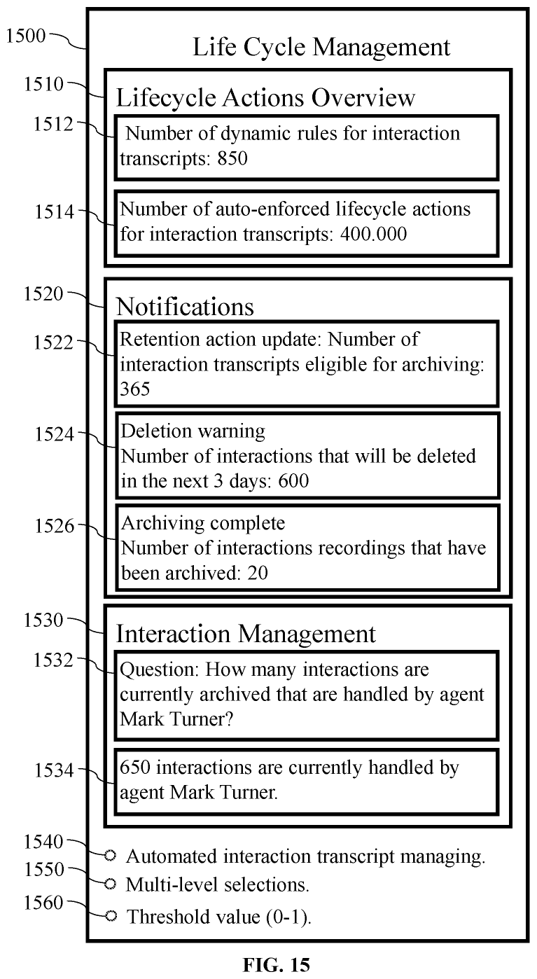

A lifecycle management portal 308 may be a user interface which allows users, e.g. using user device 230, to interact with a system of an embodiment the invention. It may also be used to configure the dynamic interaction management (DIM) 312, e.g. by providing improvement and feedback 310 of users to dynamic interaction management 312 and retrieve auto-enforcement of recommendations, e.g. recommendation from recommendation application 314, and to view the overview of lifecycle actions. Portal 308 may also provide statistics of interaction management and notifications, e.g. in form of a lifecycle action overview 1510, a notifications summary 1520 or an interaction management interface as shown in example user interface in FIG. 15.

A recommendation application 314 may be a service that can automatically generate suggestions for rules or action categories for rule for an interaction transcript, e.g. based on evaluating decision parameters present in an interaction transcript using machine learning, e.g. generative artificial intelligence. For example, generative AI may be used to suggest action categories such as copying or retaining an interaction transcript from storage X to storage Y. Recommendations can cover actions such as transfers, archiving, and deletion based on rules and compliance requirements.

A recommendation engine 314 may automatically generate rule recommendations for managing an interaction transcript using machine learning, e.g. using generative artificial intelligence. Recommendation engine 314 may automatically apply generated rule recommendations for managing the interaction transcript to the interaction transcript. For example, a user, e.g. a user using user computing device 230 or 304, may enable automatic implementation of the recommendations made by generative AI.

Continuous improvement and feedback module 310 may be a service that allows periodically updating selected one or more action categories within an applied rule, e.g. using machine learning. For example, module 306 can be used to monitor incoming interaction transcripts, e.g. decision parameters such as interaction metadata items or interaction management factors. A previously recorded and stored interaction transcript may be updated in response to interaction metadata received as part of a subsequently received interaction transcript. For example, rule R1 for interaction transcript X of client A included storing interaction transcript for a period of 2 months. Interaction transcript Y of client A included an updated response to a previous question and as a result, interaction transcript X includes outdated information. Accordingly, rule R1 for interaction transcript X may be updated and updated rule R2 may include deleting interaction transcript X and rule R3 for interaction transcript Y may include an action category store interaction transcript Y in storage S.

A dynamic interaction management (DIM) 312 may have access to metadata of each interaction, e.g. recorded via recording application 302 and stored in a database, e.g. interaction metadata database 316, as well as to storage and compliance databases. Depending on the selected lifecycle policy for a given interaction, DIM module 312 can convey inputs to storage lifecycle management application 322 that may distribute a recording into active storage 324, archive storage 326, and external storage 328.

An interaction lifecycle management service may be a service that executes action categories that may have been selected for rules of interaction transcripts. For example, service 322 may carry out actual operations of data storage such as uploading interactions transcripts to a selected storage, e.g. storage 324, 326 or 328. Service 322 may be used to execute action categories such as archive, copy, move or delete.

Table 1 shows example instructions for service 322, e.g. to initiate uploading of an interaction to a selected storage:

TABLE 1

| # | API endpoint | /storage/Action/interactionId |
|---|---|---|
| 1 | HTTP Method | POST |
| 2 | Context | Storage actions |
| 3 | Response | Performs storage action for given interaction |

Table 2 shows example instructions for service 322, e.g. to update storage action categories for selected interaction transcripts:

TABLE 2

| # | API endpoint | /storage/Action/interactionId |
|---|---|---|
| 1 | HTTP Method | PUT |
| 2 | Context | Storage actions |
| 3 | Response | Updates storage action for given interaction |

Table 3 shows example instructions for service 322, e.g. to delete selected interaction transcripts:

TABLE 3

| # | API endpoint | /storage/interactionId |
|---|---|---|
| 1 | HTTP Method | DELETE |
| 2 | Context | Storage actions |
| 3 | Response | Deletes the current interaction |

Table 4 shows example instructions for service 322, e.g. to retrieve interaction information.

TABLE 4

| # | API endpoint | /storage/Action/interactionId |
|---|---|---|
| 1 | HTTP Method | GET |
| 2 | Context | Storage actions |
| 3 | Response | Retrieves information of interactions |

Active Storage 324, also known as primary or operational storage, may be a database for storing frequently accessed interaction transcripts. A frequently accessed interaction may be accessed, e.g. once a day, once a week, once a month. Active storage 324 may be optimized for quick access and high performance, e.g. it may allow rapid read/write operations and can be used for storing recent customer interaction transcripts, ongoing call recordings, and, for example, decision parameters which may be required for immediate operational needs, e.g. used in the determination of decision categories.

Archive Storage 326 may be intended for interaction transcripts or data present in interaction transcripts that is not needed for day-to-day operations but is desired to be retained. e.g. for longer time period such as a year, e.g. for compliance, historical reference, or backup purposes. Storing data in archive storage 326 may be more cost-effective than storing data in active storage. Archive storage 326 may be optimized for data that is accessed infrequently, e.g. once a month or one a year, and can be used for storing historical data, completed records, or data subject to regulatory retention requirements. Used for keeping old call recordings, completed customer interaction transcripts, and historical performance data.

External storage 328 may be storage that is not part of a contact center or a system, e.g. external storage may be storage provided by a third party, e.g. an external cloud-storage provider. For example, external storage can include off-site (e.g. located in a geographically distinct place from the primary system) physical storage and/or cloud-based storage. For example, for “copy” and “move” action categories, external storage can be used to transfer interaction transcripts or data associated with interaction transcripts from a primary storage such as active storage 324 or archive storage 326 to an external storage 328.

Interaction metadata store 316 may be a database that includes decision parameters, e.g. interaction metadata items and/or interaction management factors, which have been identified in an interaction transcript.

Trends and model data database 318 may include interaction transcripts for which decision categories are determined or that require calculating probabilities for decision categories in the selection of action categories.

Storage database 320 may include interaction transcripts for which an applied rule included the selection of a storage action category.

A dynamic interaction management module 312 may be configured to manage interaction transcripts based on dynamic rules, e.g. to generate dynamic rules for the processing of interaction recordings automatically. Dynamic rules may be rules for managing interaction transcripts can be set based on content that is present in an interaction recording. For example, content in an interaction recording X which may include reference to a specific agent Y may lead to the generation of a rule that includes storing the interaction recording on a server that can be accessed by agent Y. A generative model may be used in the creation of the rules or parameters that may be used in the decision making process.

Within an interaction transcript, one or more decision parameters may be identified. Decision parameters, e.g. data points obtained from the interaction metadata and extracted directly from interaction transcripts themselves can be used in the generation of dynamic rules for managing interaction transcripts. Decision parameters may further include interaction metadata, as well as sentiment scores and customer information in the generation of dynamic rules. Table 5 includes example decision parameters than may be derived from an interaction transcript, e.g. generated for an interaction via recording application, e.g. recording application 202:

TABLE 5

| # | Variable Name | Purpose |
|---|---|---|
| 1 | Agent | Agent name/Id which handled the interaction |
| 2 | Team | Team name/Id |
| 3 | Skill | Skill used to handle the interaction |
| 4 | Dnis | Dialed number identification |
| 5 | Ani | Automatic number identification |
| 6 | Campaign | Focused segmented calls/campaign id |
| 7 | Region | Region where the interaction was handled |
| 8 | Customer Type | Type of the customer |
| 9 | Interaction Type | Call recording, Screen recording, Email, |
| | | Chat transcript, Digital |
| 10 | Sentiment Score | Overall sentiment and emotion of the call |
| 11 | Interaction | Personal information, financial information |
| | Sensitivity | |
| 12 | Historical | Rules selected for previous interactions |
| | Interactions | |
| 13 | Customer | Different rules might apply based on the |
| | Segmentation | customer's segment or profile, such as age, |
| | | purchasing history, etc. |
| 14 | Call Duration | Length of customer call, short - archive, |
| | | long -review |
| 15 | Customer | Satisfaction scores also influence how |
| | satisfaction | calls are stored |
| | score | |
| 16 | Date and Time | Date and time, business hours/non-business hours |
| 17 | File size | The size of the interaction |
| 18 | Call Outcome | A call outcome if customers query is resolved |
| 19 | Language | Interactions in different languages might |
| | | be processed differently |
| 20 | Call Type | Whether it's a sales call, support call, |
| | | follow-up, etc., |
| 21 | Location of | The geographic location of the caller |
| | Caller | |
| 22 | Priority Level | If calls are prioritized (e.g., VIP |
| | | customers), those priority levels might |
| | | influence file handling decisions |
| 23 | Seasonality | Different rules might apply at different |
| | | times of the year, such as during peak |
| | | seasons or off-peak periods |
| 24 | Marketing | If the call is related to a specific |
| | Campaigns | marketing campaign, special rules might |
| | | apply for how it is handled. |

FIG. 3B illustrates a system of the main components for lifecycle management that is required, e.g. for the contact center solution.

A recording application, e.g. recording application 350, may be a specialized application that can be used to capture, store, and manage various forms of customer interactions. These interactions can include voice calls, video calls, emails, chat sessions, and social media communications. A recording application may be connected to queue service 352. When a new interaction is initiated, e.g. when an agent connects to a customer, a recording application may send a notification to Queue service 352. Such a notification of an initiation of an interaction may include or may consist of decision parameters, e.g. decision parameters as shown in table 5.

Queue service 352 may retrieve interaction transcripts and, e.g. interaction metadata as part of the interaction transcripts such as notifications of initiated and terminated interactions, e.g. using and may provide interaction transcripts to computing device 354, e.g. a server. Computing device 354 may store retrieved interaction transcripts in a database, e.g. database 356.

Server 356 may include processors that can execute applications, e.g. dynamic interaction management (DIM) 312. DIM module 312 executed by a processor of server 354 may be used to managing interaction transcripts based on dynamic rules. For example DIM module 312 may access database 356, queue 358 and database service 360 and may be connected to storage modules 362, 364 and 366. DIM module 312 may be executed by a processor of server 354 may generate a dynamic rule which may be provided to management application, e.g. interaction lifecycle management application 322.

Database 356 may include decision parameters, e.g. interaction metadata and interaction management factors. It may interact with DIM by storing or providing interaction transcripts and decision parameters.

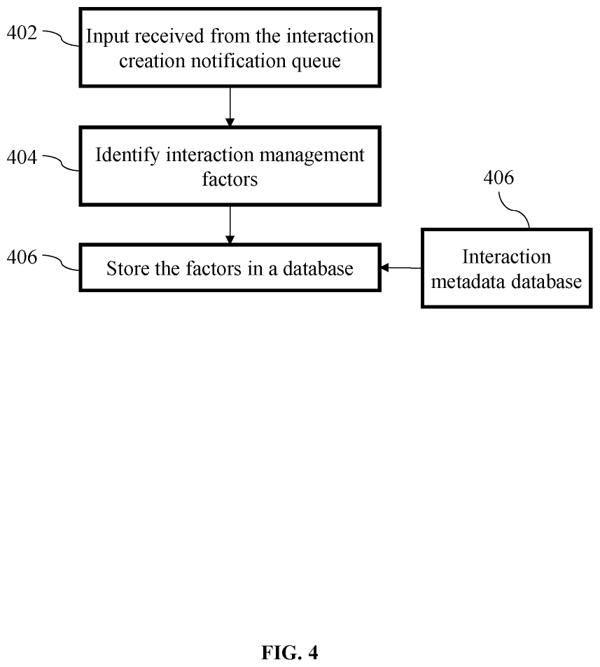

FIG. 4 illustrates operations in the retrieval of decision parameters from interaction transcripts. In operation 402, input(s) such as interaction transcripts may be received from a interaction creation notification queue, e.g. queue 352. Decision parameters, e.g. interaction management factors, may be identified (operation 404) in the retrieved interaction transcripts and may be stored in a database (operation 406), e.g. database 356. Decision parameters may also be retrieved from a database that stores decision parameters, e.g. interaction metadata database 316.

Queue 358 is a service which holds the notifications and messages. For example, it can be used to hold or carry out the pre-processing and ETL (extract, transform and load)-related requests. ETL related requests may include the provision of interaction management factors, e.g. which have been received by a recording application to server 354 via extraction of decision parameters, normalization of decision parameter (transform) and the generation of rules (load).

Job Servers 362 may be one or more services which are responsible for pre-processing and generalization of data, e.g. the normalization of decision parameters.

Database 364 may be an interaction database which can hold, for example, rules, action categories present in rules and/or decision categories which can be selected as action categories in the generation of rules. Database 364 may also store pre-processed, e.g. normalized, decision parameters generated by job server 362.

Services 360 may include ML models and predictions mechanisms. These primarily used for calculating of probabilities for the at least one decision category for the rule using the one or more decision parameters. Services 360 may include a category identification engine and storage action selection engine and may further be connected to interaction database 366 and model prediction database 368.

Storages 370, 372 and 374 may store an interaction, e.g. according to a generated rule for an interaction.

For example, storage 370 may be an active/standard storage such as a cloud-based storage solution. Storage 372 may be an archive storage such as a cloud-based archival solution. Storage 374 may be an external storage such as a cloud-based storage solution.

Browser 376 may be configured to provide a user, e.g. user using computing device 304, with a user interface that allows a user interacting with DIM 312.

Load balancer 378 may direct incoming requests from users, e.g. using browser 376, to one of servers 354. Server 354 may distribute requests of users evenly between the servers.

Content delivery system (CDN) 380 may send static content, e.g. images and other files that are stored in storage, e.g. storage 370 to users via browser 376, e.g. following a request from a user via browser 376.

A Domain Name System (DNS) may translate domain names, e.g. domain names of a website such as www.example.com, into Internet protocol addresses (e.g. Pv4 addresses such as 192.0.2.146) that can be used by browsers of computing devices, e.g. to identify each other in a network. For example, a DNS may allow the system identifying a user, e.g. using browser 376 on user device 602, who interacts with a user interface such as lifecycle management portal 604.

Decision parameters may include, for example, interaction metadata. Interaction metadata may be retrieved as part of an interaction upload operation and may include various parameters that are associated with an interaction. For example, interaction metadata may include an agent identifier (agent ID). An Agent ID may allow identifying an agent who handled an interaction. For example, an agent ID can influence decisions about archiving for quality assurance purposes or identifying patterns in customer service for particular agents. For example, interaction metadata may include a team identifier (Team ID). A team ID may provide information about the team or division of an agent. The indication of a team may allow a DIM to retain or delete interactions that are specify to a certain group of agents. For example, interaction metadata may include a skill identifier (skill ID). A skill ID may indicate a specific skill or expertise which was applied by an agent during the interaction. A skill may be a characteristic or qualification of an agent that corresponds to a received query of an agent. For example, a skill for an agent may be based on a channel type and an agent, who is trained in responding to customer queries via a text-based interaction may be skilled in handling an interaction with a customer, who has contacted a contact center via a text-based interaction request. A skill may be important for categorizing and analyzing interactions based on the skill required. A skill ID can influence a decision on whether interactions may be retained, e.g. for training purposes or for a review. For example, interaction metadata may include a Dialed Number Identification Service DNIS. A DNIS may allow identifying a specific service or department which can be called by a customer. It can be useful for managing interaction transcripts by enabling a decision on data categorization and retention based on service demand. For example, interaction metadata may include an Automatic Number Identification (ANI). An ANI may provide a caller's phone number which can be essential, for example for tracking repeat interactions from the same customer, personalizing customer service, and making informed decisions about data storage based on customer importance or interaction frequency. For example, interaction metadata may include a Campaign identifier (campaign ID). A campaign ID may indicate a specific marketing or outreach campaign associated with the interaction, crucial for segmenting interactions based on campaign objectives, and determining the archival or deletion of interactions based on campaign relevance and outcomes.

Decision parameters may include, for example, a parameter identifying a region. A region may provide data on where an interaction was handled, e.g. the region of a contact center agent who handled the interaction and the geographic location where the interaction took place.

Decision parameters may include, for example, a parameter customer type. A customer type may describe the customer who took part in an interaction, e.g. a premium or VIP customer etc..

Decision parameters may include, for example, a interaction sentiments. For example, interaction sentiments may include an interaction sentiment “Interaction Type”. An interaction type, e.g. call recording, screen recording, e-mail, chat transcript, digital, etc., may determine a specific format and channel of an interaction. Different interaction types may have varying regulatory retention requirements and relevance for future reference, impacting decisions on archiving, retention, and deletion and, thus, may provide restrictions on the appropriate storage method and duration.

For example, interaction sentiments may include an interaction sentiment “Sentiment Score” that includes a value for the overall sentiment and emotion of a customer during a call and may allow gauging the emotional tone of the interaction, important to determine lifecycle action for example, high sentiment scores might lead to longer retention for quality training purposes or immediate archival for compliance.

For example, interaction sentiments may include an interaction sentiment “Interaction Sensitivity”. An interaction may include an interaction sensitivity sentiment, e.g. when personal, financial information are disclosed during a call that can be critical for compliance with privacy and data protection regulations. Interactions containing sensitive information may require enhanced security measures, restricted access, and potentially shorter retention periods to mitigate risk.

For example, interaction sentiments may include an interaction sentiment “Historical Interactions Score”. Information on lifecycle rules created for previous interactions may allow taking into account how similar interactions were managed previously, aiding in consistent and informed decision-making for current interactions. It helps in understanding patterns and efficacy of past rules, influencing decisions on current interaction management.

For example, interaction sentiments may include an interaction sentiment “Customer Satisfaction Score” that can indicate a strategic value of an interaction. For example, high satisfaction scores can indicate interactions worth retaining longer for training or marketing insights, while lower scores might prompt immediate review and analysis for service improvement.

For example, interaction sentiments may include an interaction sentiment “call outcome”.

A sentiment call outcome may allow determining a result or resolution of a call, which can be beneficial for categorizing interactions based on their conclusion. Successful resolutions can be archived for best practice models, while unresolved issues may require longer retention for ongoing follow-ups or legal considerations.

Decision parameters may include, for example, “customer Segmentation”. For example, different rules may be applicable for managing an interaction transcript, e.g. rules can be based on customer age, purchasing history, etc

Decision parameters may include, for example, “call related factors”. For example, call related factors may include a parameter “call duration”. A call duration may be the total time span of a customer call, important for identifying long or short interactions which can influence archiving or priority decisions for an interaction transcript.

For example, call related factors may include a parameter “date and time”. A parameter date and time may allow setting an exact timing for an interaction recording and can be crucial, e.g. for tracking peak hours and seasons, and, thus, allows chronologically recording data, e.g. decision parameters for an interaction transcript.

For example, call related factors may include a parameter “file size”. A file size of a recorded interaction transcript may be relevant for storing the interaction transcript.

For example, call related factors may include a parameter “language of interaction”. Identifying a language used during an interaction may allow categorizing interaction transcripts by language and may allow deciding on specialized handling or routing based on language capabilities.

For example, call related factors may include a parameter “call type”. A parameter call type may allow classifying an interaction transcript as an interaction that includes, for example, an inquiry, a complaint, etc.. A parameter call type may thus allow identifying whether managing of an interaction transcript should be prioritized, e.g. in case of a complaint.

For example, call related factors may include a parameter “location of caller”. The caller's geographical location can be important for regional compliance, targeted marketing analysis, and managing time zone-related interactions.

For example, call related factors may include a parameter “priority level”. A priority level may indicates an urgency and can provide guidance on how quickly an interaction should be handled, stored, and the order in which it is archived or deleted.

For example, call related factors may include a parameter “seasonality”. Seasonal trends, e.g. crucial for preparing and managing interaction volume fluctuations and strategizing marketing or support efforts may be recorded within an interaction recording.

For example, call related factors may include a parameter “marketing campaigns”. Marketing campaigns may include links interactions to specific campaigns, important for evaluating campaign effectiveness and for context-specific data retention and analysis.

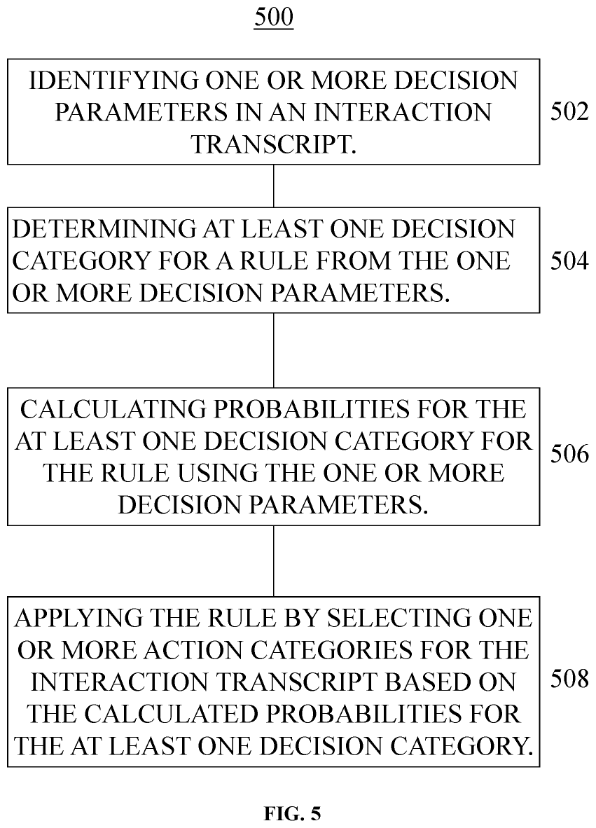

FIG. 5 shows a flowchart of a method 500 for managing interaction transcripts based on dynamic rules, e.g. an interaction transcripts which may have been received by computing device 202. The system displayed in FIG. 2 and the method shown in FIG. 5 may refer to the selection and/or generation rules for managing, e.g. handling, interaction transcripts which have been received from an agent device, e.g. 210, or a database, e.g. server 220, or a user computing device 230 however, the system and the method may also be used to select rules for managing an interaction transcript from an interaction recording when executed on a server or agent device. According to some embodiments, some or all of the steps of the method are performed (e.g., fully or partially) by one or more of the computational components, for example, those shown in FIGS. 1 and 2.

In operation 502, one or more decision parameters may be identified in an interaction transcript. For example, a decision parameter may be a data item that is part of an interaction recording such as a name of a customer, e.g. customer X, or a data item identifying the type of an interaction recording, e.g. video chat or text chat. The identification of decision parameters may proceed, for example by identifying snippets of programming code in an interaction recording that includes a decision parameter. Snippets of programming code in an interaction recording may be identified using a DIM module 312 or server 354. For example, when an IP address is identified in an interaction transcript, the address may be used to identify the location of a caller contacting a contact center.

In operation 504, at least one decision category for a rule may be determined from the one or more decision parameters. A decision category may be a category that includes one or more possible options for handling an interaction transcript by a system and may be identified from decision parameters of an interaction transcript. For example, a decision category may be identified based on decision parameters. Decision parameters, e.g. normalized decision parameters, may be submitted to a machine learning (ML) model, e.g. a Large Language Model (LLM). An ML model may determine at least one decision category for a rule from the one or more decision parameters for an interaction. Decision parameters may serve as contextual variables. For example, when a decision parameter includes a completion date of a task carried out by an agent and may be incorporated in a prompt and submitted to a ML model, e.g. a LLM, a decision parameter “storing” may be suggested, e.g. by a ML model, as a possible decision category for an interaction. Alternatively, decision categories for an interaction, e.g. a specific customer group may be predefined, e.g. decision categories copy, delete and archive may be selected as decision categories for interaction transcripts. Decision categories may be selected as action categories for handling an interaction transcript by calculation of probabilities for one or more decision categories that have been determined from the one or more decision parameters.

In operation 506, probabilities for the at least one decision category may be calculated for the rule using the one or more decision parameters. For example decision categories may be encoded. For example, a decision parameter such as “location of a caller” may be converted from a text-based form to a numerical form. E.g. when a caller contacts a contact center from North America, the location North America may be expressed as a vector variable [0-1-0] whereas when a caller contacts a contact center from Europe they are assigned a vector variable [0-0-1]. Vectorized variables of decision parameters may be normalized and may be used, e.g. to identify a server location for an interaction transcript of a caller that is within the continent where the caller is based.

In operation 508, a rule may be applied by selecting one or more action categories for the interaction transcript based on the calculated probabilities for the at least one decision category. A decision category may be selected as an action category when the selection of an action category is based on a single-level selection and a rule is based on a decision category with the highest probability. For example, a single-level selection for interaction transcript A may be applied for decision categories “retention” having a probability of 0.5, “deletion” having a probability of “0.3” and “copy” having a probability of 0.2. Decision category “retention” has the highest probability of the three decision categories and may be selected as a single action category and may be applied in a rule for managing interaction transcript A. As a result, a retention action identified in decision parameters for interaction transcript A may be applied to interaction transcript A. For example a retention action may be “storing interaction A for 30 days on server X”.

One or more decision categories may be selected as action categories when the selection of an action category is based on a multi-level selection and a rule is based on decision categories whose calculated probabilities lie above a pre-set threshold value. For example, a multi-level selection for interaction transcript B may be applied for decision categories “retention” having a probability of 0.5, “copy” having a probability of “0.3” and “deletion” having a probability of 0.2. A pre-set threshold value for the selection of decision categories of interaction transcript B may have a value of 0.25. Decision categories “retention” and “copy” have probability values that are higher than the pre-set threshold value and decision category “deletion” a probability value below 0.25. As a result, a retention action and a copy action may be applied to interaction transcript B. For example a combination of retention action and copy action may be “create a copy of interaction transcript B on storage X and store the copy of interaction transcript B on storage X for a period of Y days.

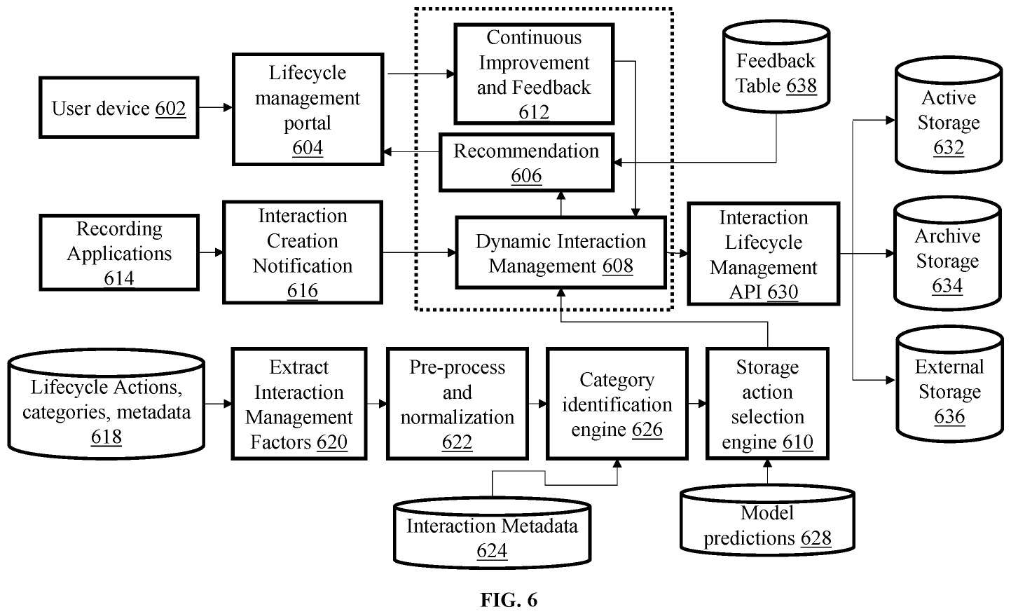

FIG. 6 is a flowchart illustrating the processing of interaction transcripts in the generation of rules for managing interaction transcripts, e.g. in lifecycle management which may be required, e.g. for a contact center solution, according to one embodiment. User 602 of a contact center, e.g. a customer, can access lifecycle management portal 604 via a computing device such as computing device 602. An example of an interface of a lifecycle management portal is provided in FIG. 15. Portal 604 may allow users providing feedback or suggestions for improvement, e.g. via continuous improvement and feedback application 612, e.g. a user may approve/reject suggestions or feedback for managing interaction transcripts by dynamic interaction management application 608. A user of portal 604 may be presented with recommendations for managing interaction transcripts. For example, recommendations for managing interaction transcripts may be generated by dynamic interaction management application 608 and may be transmitted to lifecycle management portal 604 via recommendation service 606. Dynamic interaction management application 608 may also automatically apply rules, that have been generated based on selected action categories, e.g. action categories for rules that are stored in storage action section engine 610. A recording application, e.g. recording application 614 may generate or retrieve interaction recordings and may send them to interaction creation notification application 616. Application 616 may notify dynamic interaction management application 608 of the retrieval of a new interaction transcript. Decision parameters, e.g. metadata, present in interactions may be stored in database 618. Decision parameters may be extracted from interaction transcripts, e.g. using extraction interaction management factor application 620 and may undergo pre-processing and normalization, e.g. via pre-processing and normalization application 622. Decision categories for an interaction may be identified, e.g. based on retrieved decision parameters, e.g. pre-processed and normalized decision parameters processed by application 622 or may be retrieved from database that stores decision parameters, e.g. interaction metadata databased 624 that was retrieved as part of earlier interaction transcripts (626). Identified decision categories may be managed by a storage action selection engine 610. For example, storage action selection engine 610 may calculate probabilities for decision categories or may retrieve probabilities for decision categories in form of model predictions 628, e.g. previously calculated probabilities may be assigned to decision categories. Dynamic interaction management 608 may be an application that selects one or more decision interaction categories as action for an interaction transcript based on calculated probabilities, e.g. using a single-level selection or a multi-level selection. Rules including selected action categories may be sent to interaction lifecycle management application 630. Application 630 may execute rules for interaction transcripts, e.g. by retaining interaction transcripts in storage, e.g. database 618, deleting an interaction transcript from storage and/or copying interaction transcripts to a new storage location, e.g. active storage 632, archive storage 634 or external storage 636. Feedback table 638 may be a database or storage for user or agent feedback on interactions, system usability, or recommendations, e.g. a recommendation service 606 may access table 638 to retrieve feedback in the provision of recommendations for managing interaction transcripts to user device 602, e.g. via lifecycle management portal 604.

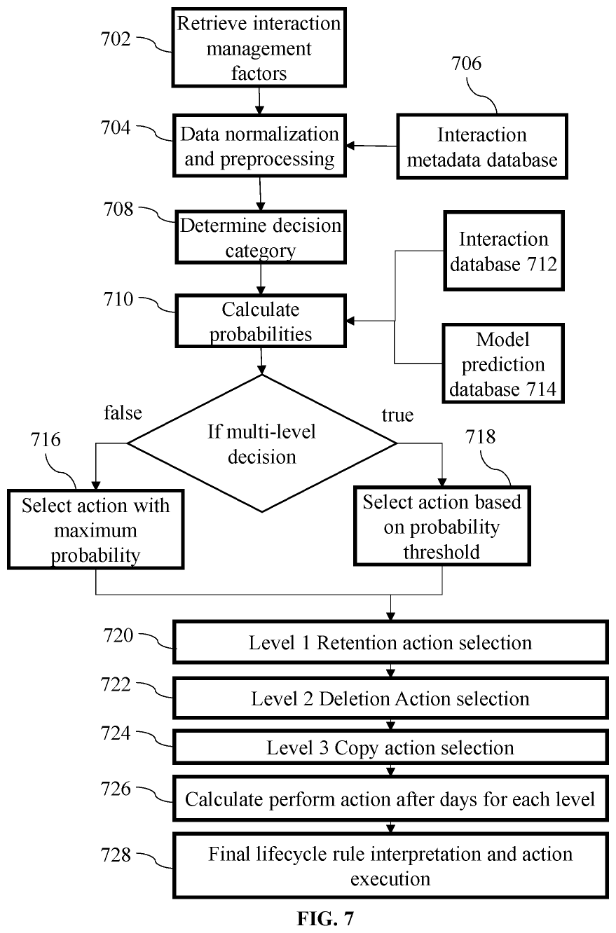

FIG. 7 provides an overview of example operations in the processing of interaction transcripts to generate rules for the management of interaction transcripts, e.g. in lifecycle management, according to one embodiment. After retrieval of decision parameters, e.g. interaction management factors that have been identified in an interaction transcript (operation 702), identified decision parameters undergo data normalization and pre-processing (operation 704). Decision parameters, e.g. interaction metadata present in interaction metadata database 706 for previously recorded interaction transcripts may be used in the preprocessing operation 704. In operation 708, decision categories are identified for an interaction. The type of decision categories may be identified based on decision parameters resent in an interaction. In operation 710, probabilities are calculated for identified decision categories. In some embodiments, decision parameters previously retrieved in interaction transcripts may be used in the calculation of probabilities, e.g. such decision parameters may be provided by interaction database 712 or model prediction database 714. Based on the calculated probabilities for the decision categories one single action for an interaction transcript may be identified that has the highest probability of all determined decision categories for an interaction transcript (operation 716). In one embodiment, in a multi-level decision, one or more selected action categories may be selected for which a probability lies above a pre-set threshold (718). For example, in case for a multi-level decision, three action categories may be selected for a rule, such as retention action (operation 720, level 1), deletion action (operation 722, level 2) and copy action (operation 724, level 3). For each action category, a time period for the performance of such an action category may be calculated. Calculated time periods for selected action categories and action categories for a rule (726) may be executed, e.g. by an interaction lifecycle management application 630 (operation 728).

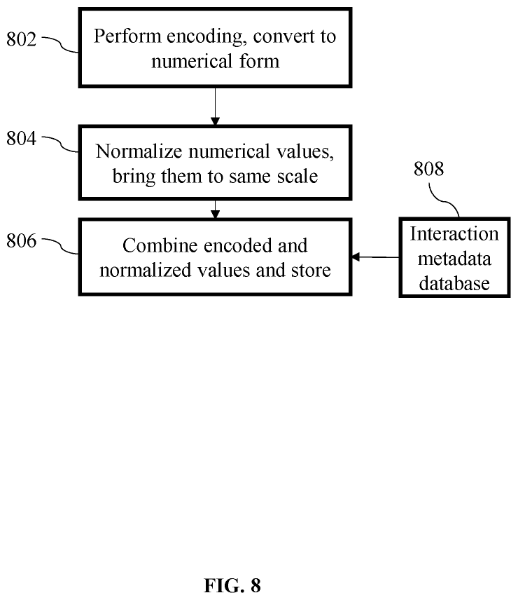

FIG. 8 illustrates example operations in the pre-processing of decision parameters, according to one embodiment.

Decision parameters that are identified in an interaction transcript may be retrieved in various formats. For example, decision parameters may be in form of numerical values, text values and scales, e.g. a 5 pointer scale or a 10 pointer scale. The preprocessing of decision parameters may include transforming decision parameters, encoding decision parameters and converting decision parameters into a numerical form (operation 802).

Decision parameters may be modified, e.g. to allow comparing two different parameter values, e.g. a parameter value in a numerical format and a parameter value in a text format with each other. For example, many of the context variables such as agent, team, skill, etc., are categorical and should be encoded into a numerical format.

In one embodiment, a One-Hot encoding method may be used to convert each categorical variable into a binary vector. An example of a One-Hot encoding method is shown in example formula 1. For example, for a category xᵢ, the value 1 corresponds to the position of the category.

$$OneHot ( xi ) = [ 0 - 1 - 0 ] \qquad Formula 1$$

The preprocessing of decision parameters may include normalization of decision parameters (operation 804). Normalization of decision parameters may include converting diverse forms of data, e.g. parameters, into a consistent and standardized format, making them usable for algorithmic processing. Numerical variables may be normalized, e.g. all numerical variables such as call duration, may be normalized to allow comparison of numerical variable with each other. For example, for the normalization a Min-Max Normalization method may be used. This example embodiment may scale the values to a specific range like [0, 1].

$$min Max ( {x}_{i} ) = \frac{{x}_{i} - min ( x )}{max ( x ) - min ( x )} \qquad Formula 2$$

For example, encoded and normalized decision parameters, e.g. variables, may be combined in a context value, that includes one-hot encoded variables and normalized numerical variables (operation 806). An example formula for a context value is shown in example formula 3.

$$Context = ( Nomalized interaction parameters , Normalized numerical variables ) \qquad Formula 3$$

Previously pre-processed decision parameters, e.g. interaction metadata items, of previous interaction transcripts stored in an interaction metadata database 316, e.g. previous interaction transcript X for a customer Y, may be combined with decision parameters that have been identified in a following interaction transcript Z for customer Y (operation 808).

In the management of interaction transcripts, e.g. as part of interaction lifecycle management of interactions of a contact center, an interaction may be managed based on dynamic rules. Dynamic rules may include one or more action categories that can be selected based on the rule.

For example, an action category may be “archive”. Action category archive may include transferring interactions which are older or less frequent accessed to a separate storage area. Action category archive may allow reducing the load on primary storage systems while keeping interaction transcripts or data present interaction transcripts data accessible for future reference, compliance, or analysis purposes.

For example, an action category may be “delete”. Applying a rule including an action category delete may permanently remove an interaction transcript or data present in an interaction transcript from a storage location, e.g. storage 370, 372 or 374. This action category may be applied for interaction transcripts that are no longer needed for operational, legal, or compliance reasons, or to free up storage space.

For example, an action category may be “KeepInActive”. Applying a rule including an action category keepinactive may retain an interaction transcript or data present in an interaction transcript within the system but an interaction transcript may be stored in a less accessible state. For example, an interaction transcript or data within an interaction transcript may not be currently relevant but could be used in the future, e.g. an interaction transcript may be retained for a certain period, e.g. 6 months, for compliance reasons.

For example, an action category may be “MoveToExternalStorage”. This action category may transfer interaction transcripts or data present in interaction transcripts from a primary storage of a system to an external storage solution. An external storage solution may be a data cloud storage, for example an off-site physical storage facility. Action category MoveToExternalStorage can be applied in a rule e.g. for long-term storage of interaction transcripts, cost efficiency, or as part of a data backup strategy.

For example, an action category may be “CopyToExternalStorage”. This action category may move interaction transcripts or data present in interaction transcripts by creating a duplicate of an interaction transcript or data present in an interaction transcript and may store it in an external storage system. The key difference is that the original data remains in the primary system. This can be used, for example, for creating backups or for additional security.

For example, an action category may be “DeleteArchive”. This action category may delete an interaction transcript or data present in an interaction transcript from archive storage, e.g. by archiving an interaction transcript, and then deleting an interaction transcript, e.g. after a certain period such as a months or a year, or under specific conditions, e.g. when a customer stopped using contact center to handle their product queries related to a specific product.

For example, an action category may be “KeepForever”. This action category may retain an interaction transcript or data present in an interaction transcript for an indefinite time period. For example, an action keepforever may be used since an interaction transcript is of high importance to a customer, for legal requirements, or its value for business insights or historical records.

For example, an action category may be “Backup and Archive”. This action category may lead to creating a backup of a interaction transcripts, e.g. for recovery purposes, which is then archived. A backup and archive action category may allow storing interaction transcripts by moving less frequently accessed interaction recordings from a primary storage to an archive storage.

Dynamic rules that include multi-level selections of decision categories may be essential to complex management combinations of interaction transcripts, e.g. in interaction lifecycle management of a contact center. For example, in a multi-level selection, a rule may be applied to an interaction transcript that includes one or more action categories. For example, a rule may specify a sequence of action categories over a certain time period: A first action category may be “KeepInActive” for 30 days, a second action category may be archive for 90 days, and a third action category may be delete.

Examples of three rules, Level 1, Level 2 and Level 3, that include a multi-level selection of action categories for an interaction transcript may read:
1. Level I: Retention category: With actions
   1. Archive
   2. KeepInActive
   3. KeepForever
   4. Backup and Archive
2. Level 2: Deletion category: With actions
   1. Delete
   2. DeleteArchive
3. Level 3: Copy category: With actions
   1. CopyToExternalStorage,
   2. MoveToExternalStorage

A general formula for action categories D for an interaction may be shown in example formula 4.

$$Action categories D = \{ Archive , Delete , KeepInActive … … N \} \qquad Formula 4$$

Using a multi-level decision framework allows for the creation of dynamic rules that specify a sequence of actions and their durations. For example, a rule could be defined as a sequence of (Action, Duration) pairs, such as (Retain, 30), (Archive, 90), (Delete, 0), indicating that an interaction transcript or data present in an interaction transcript may be retained for 30 days, archived for 90 days, and then deleted immediately after the archival period.

Multi-level selection in the selection of dynamic rules may allow a nuanced and strategic approach to interaction lifecycle management, accommodating complex sequences of actions over specified durations to meet various operational and compliance needs.

When a selection of one or more action categories is based on a multi-level selection, a rule for managing an interaction transcript may be based on at least one decision category whose calculated probabilities lie above a pre-set threshold value. For example, a calculated probability may lie within pre-set threshold value, e.g. a threshold between 0 to 1. The lower the threshold the higher chances of selecting multiple categories. A threshold may be automatically selected, e.g. by dynamic interaction management service 608 or storage action and selection engine 610, or may be set by a user, e.g. a user using user device 602 to access a lifecycle management portal 604.

For applying a rule that includes a single action category, e.g. as part of a single-level selection, for an interaction transcript, a rule may be based on a decision category with the highest probability. For example, a user of a lifecycle management portal 604 may decide managing an interaction transcript by a single action category, e.g. retention or deletion.

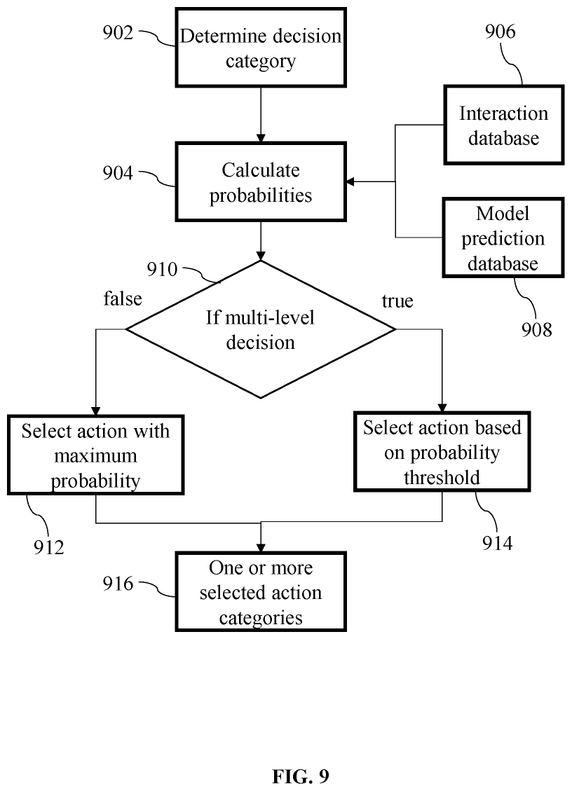

FIG. 9 discloses a flowchart that illustrates operations in the selection of one or more action categories for an interaction transcript.

In operation 902, at least one decision category for a rule may be determined for an interaction transcript from one or more decision parameters. For example, an interaction transcript may be best managed under a single-level selection, such as retention, or by a multi-level selection of categories, such as retention and deletion. In some cases, three categories—copy, retention, and deletion—may be applied in a rule.

Accurately determining the most fitting category or combination of categories for each interaction may proceed, e.g. via the one-vs-rest (OvR) classification method. Once at least one decision category is determined from decision parameters, appropriate action categories may be selected in the construction of a rule for managing an interaction transcript.

For example, available decision categories for an interaction transcript X may be retention, deletion and copy as shown in the examples in Table 6.

TABLE 6

| # | Decision categories |
|---|---|
| 1 | Retention |
| 2 | Deletion |
| 3 | Copy |

For each of the decision categories, a probability is calculated using one or more decision parameters (operation 904). Probabilities may be calculated using decision parameters, e.g. interaction metadata, which are stored in an interaction database 906. Alternatively, probabilities may be calculated using previously predicted probability values for decision categories that are stored, e.g. in a model prediction database 908.

For example, a one-vs-rest (OvR) classification approach may be used to identify the probability for each decision category. Based on the calculated probabilities for the decision categories, one or more action categories may be selected for an interaction.

The one-vs-rest (OvR) method, also known as one-vs-all (OvA), may be a strategy for handling multi-class classification problems using binary classifiers. In OvR, a single classifier is trained per class, with the samples of that class as positive samples and all other samples as negatives.

Using the classification model, one or more action categories for an interaction transcript may be selected based on calculated probabilities for at least one decision category.

Table 7 illustrates an example selection of action categories via a multi-level selection and via a single-level decision. For example, selected action categories for a multi-level decision may be retention deletion and copy and selected categories for a single-level decision may be retention.

TABLE 7

```
For multi-level decision
{
  ″Type″: ″multi-level″,
  ″SelectedCategories″: [″Retention″, ″Deletion″, ″Copy″]
}
For single action decision
{
  “Type”: “Single-action”,
  “SelectedCategories”: [“Retention”]
}
```

In operation 910, action categories for a rule for an interaction transcript may be selected based on calculated probabilities for decision categories and on the applied selection type. A selection type may specify whether a specific decision category, e.g. a decision category with the highest probability may be selected as action category 916 for a rule, also referred to as a single-level selection (912), or whether one or more decision categories whose calculated probabilities lie above a pre-set threshold value may be selected as action categories 916 for a rule, also referred to as a multi-level selection (914). For example, for multi-level decision selected categories can be any combination of retention, deletion or copy. For a single action decision, it can be only one action category out of the determined decision categories.

A one-vs-rest (OvR) model may enable classifying decision categories in multi-class problems, for example, it can be used in cases in which two or more classes, e.g. two decision categories, need to be classified.

A one-vs-rest (OvR) method, also known as one-vs-all (OvA), can be a strategy for managing multi-class classification problems using binary classifiers. In a OvR, a single classifier is trained per class, with the samples of that class as positive samples and all other samples as negatives. This process is repeated for each class.

It may leverage binary classifiers (designed for two classes) to tackle multi-class problems. For example, a logistic regression may be used to perform OvR classifications.

Selection of decision category out of 3 available categories, Retention, Deletion and Copy:

Classifiers for each category, (R, D, C) i.e., Retention, Deletion and Copy respectively for training:
Category Retention R: Class R is positive, Classes D and C as negative
Category Deletion D: Class D as positive, Classes R and C as negative
Category Copy C: Class C as positive, Classes R and D as negative
   Example with Sample Dataset:

A main dataset includes decision parameters, e.g. various features (F1, F2, F3, etc.) and decision categories. For example, decision parameters F1, F2, F3 . . . Fn can be the interaction management factors such as agent, location, team, sentiment score etc..

A main dataset may include various features (F1, F2, F3, etc.) which are interaction management factors and the actual category labels, e.g. as shown in the examples in Table 8.

TABLE 8

| ID | F1 | F2 | F3 | Category |
|---|---|---|---|---|
| 1 | 5.1 | 3.5 | 1.4 | R |
| 2 | 4.9 | 3.0 | 1.4 | D |
| 3 | 4.7 | 3.2 | 1.3 | C |
| 4 | 4.6 | 3.1 | 1.5 | R |
| . . . | . . . | . . . | . . . | . . . |

### Training Dataset for Deletion (D):

For training a deletion decision category in OvR, a dataset may be modified such that all instances of deletion are labelled as positive (1) and all other categories as negative (0). Accordingly, an example dataset for deletion may be shown in table 9.

TABLE 9

| ID | F1 | F2 | F3 | Label |
|---|---|---|---|---|
| 1 | 5.1 | 3.5 | 1.4 | 0 |
| 2 | 4.9 | 3.0 | 1.4 | 1 |
| 3 | 4.7 | 3.2 | 1.3 | 0 |
| 4 | 4.6 | 3.1 | 1.5 | 0 |
| . . . | . . . | . . . | . . . | . . . |

### Training Dataset for Retention (R):

Similarly, for a retention decision category, retention instances may be labelled as positive. Accordingly, an example dataset for deletion is shown in table 10.

TABLE 10

| ID | F1 | F2 | F3 | Label |
|---|---|---|---|---|
| 1 | 5.1 | 3.5 | 1.4 | 1 |
| 2 | 4.9 | 3.0 | 1.4 | 0 |
| 3 | 4.7 | 3.2 | 1.3 | 0 |
| 4 | 4.6 | 3.1 | 1.5 | 1 |
| . . . | . . . | . . . | . . . | . . . |

### Training Dataset for Copy (C):

For a copy decision category, copy instances may be labelled as positive. Accordingly, an example dataset for deletion is shown in table 11.

TABLE 11

| ID | F1 | F2 | F3 | Label |
|---|---|---|---|---|
| 1 | 5.1 | 3.5 | 1.4 | 0 |
| 2 | 4.9 | 3.0 | 1.4 | 0 |
| 3 | 4.7 | 3.2 | 1.3 | 1 |
| 4 | 4.6 | 3.1 | 1.5 | 0 |
| . . . | . . . | . . . | . . . | . . . |

In each training dataset, the decision parameters (F1, F2, F3, etc.) may remain the same as in the main dataset, but the label for decision categories may be adjusted to reflect a binary classification for each OvR classifier.

Logistic regression equations for each decision category may be calculated using OvR.

An equation for a decision category R (Retention) may be shown in example formula 5:

$$log ( p ( y = R \vert x ) / ( 1 - p ( y = R \vert x ) ) ) = {w}_{{R}^{T}} * x + {b}_{R} \qquad Formula 5$$

An equation for a decision category D (Deletion) may be shown in example formula 6:

$$log ( p ( y = D \vert x ) / ( 1 - p ( y = D \vert x ) ) ) = {w}_{{D}^{T}} * x + {b}_{D} \qquad Formula 6$$

An equation for a decision category C (Copy) may be shown in example formula

$$log ( p ( y = C \vert x ) / ( 1 - p ( y = C \vert x ) ) ) = {w}_{{C}^{T}} * x + {b}_{C} \qquad Formula 7$$

Obtaining the probabilities and normalization:

After training, probabilities may be calculated for each decision category for an interaction transcript based on decision parameters that belong to its respective decision category.

Example for categories R, D, C assuming x=(2, 5, 0, 1, 0) (features: x1=2, x2=5, F1=0, F2=1, F3=0):

Using our rained decision categories R, D and C (considering dummy features), as shown in table 12, probabilities may be calculated for decision categories R, D and C, e.g. according to example formulas 8, 9 or 10.

TABLE 12

| | |
|---|---|
| Category R | W_{R} = (0.4, −0.3, 0.1, −0.2, 0) |
| | b_{R} = 0.2 |
| Category D | W_{D} = (−0.2, 0.5, −0.1, 0.3, 0.1) |
| | b_{D} = −0.3 |
| Category C | W_{C} = (0.2, 0.1, 0.2, 0, −0.1) |
| | b_{C} = 0.1 |

### Category R:

$$\begin{matrix}log ( {p}_{R} / ( 1 - {p}_{R} ) ) = ( 0.4 * 2 ) + ( - 0.3 * 5 ) + ( 0.1 * 0 ) + ( - 0.2 * 1 ) + ( 0 * 0 ) + 0.2 = - 0.4 \\ {p}_{R} = 1 / ( 1 + exp ( 0.4 ) ) = 0.4013\end{matrix} \qquad Formula 8$$

### Category D:

$$\begin{matrix}log ( {p}_{D} / ( 1 - {p}_{D} ) ) = ( - 0.2 * 2 ) + ( 0.5 * 5 ) + ( - 0.1 * 0 ) + ( 0.3 * 1 ) + ( 0.1 * 0 ) - 0.3 = 1.6 \\ {p}_{D} = 1 / ( 1 + exp ( - 1.6 ) ) = 0.8315\end{matrix} \qquad Formula 9$$

### Category C:

$$\begin{matrix}log ( {p}_{C} / ( 1 - {p}_{C} ) ) = ( 0.2 * 2 ) + ( 0.1 * 5 ) + ( 0.2 * 0 ) + ( 0 * 1 ) + ( - 0.1 * 0 ) + 0.1 = 1.1 \\ {p}_{C} = 1 / ( 1 + exp ( - 1.1 ) ) = 0.7504\end{matrix} \qquad Formula 10$$

Normalizing probabilities ensures they add up to 1, representing a complete probability distribution.

The original probabilities may be summed up as shown in example formula 11:

$${sum}_{probs} = {p}_{R} + {p}_{D} + {p}_{C} = 0.4013 + 0.8315 + 0.7504 = 1.9832 \qquad Formula 11$$

Normalized probabilities may calculated by dividing each probability for retention, deletion and copy by the sum for all three probabilities as shown in example formula 12:

$${p}_{R \_ norm} = {p}_{R} / {sum}_{probs} = 0.4 \; 013 / 1.9832 = 0 \text{.2023} \qquad Formula 12$$

$${p}_{D \_ norm} = {p}_{D} / {sum}_{probs} = 0.8 \; 315 / 1.9832 = 0.4 \; 193$$

$${p}_{C \_ norm} = {P}_{C} / {sum}_{probs} = 0.7 \; 504 / 1.9832 = 0.3784$$

Selecting the decision action based on the probability threshold: For an interaction transcript one or more action categories may be selected based on the calculated probabilities for the at least one decision category.

For multi-level selections, one or more action categories for an interaction may be selected based on a probability threshold.

For example, for a multi-level decision, a probability threshold may be a value between 0 to 1, the lower the value means more chance of selection of multiple categories and a probability threshold may be assumed as T=0.2. Accordingly, action categories p may be selected by comparing their probability p with a threshold value T, as shown in formula 13:

$${R}_{select} = {p}_{R \_ norm} > T = 0.2023 > 0.2 = selected \qquad Formula 13$$

$${D}_{select} = {p}_{D \_ norm} > T = 0.4193 > 0.2 = selected$$

$${C}_{select} = {p}_{C \_ norm} > T = 0.3784 > 0.2 = selected$$

For single action category, a category with the highest probability may be selected as shown in example formula 14:

$${selected}_{category} = arg max ( {p}_{R} , {p}_{D} , {p}_{C} ) = arg max ( 0.2 \; 023 , 0.3193 , 0.3784 ) = D \qquad Formula 14$$

For multi-level decisions, the model selects all three categories eligible for the interaction.

For single action decision, the model selects action with highest probability which is category D i.e., deletion.

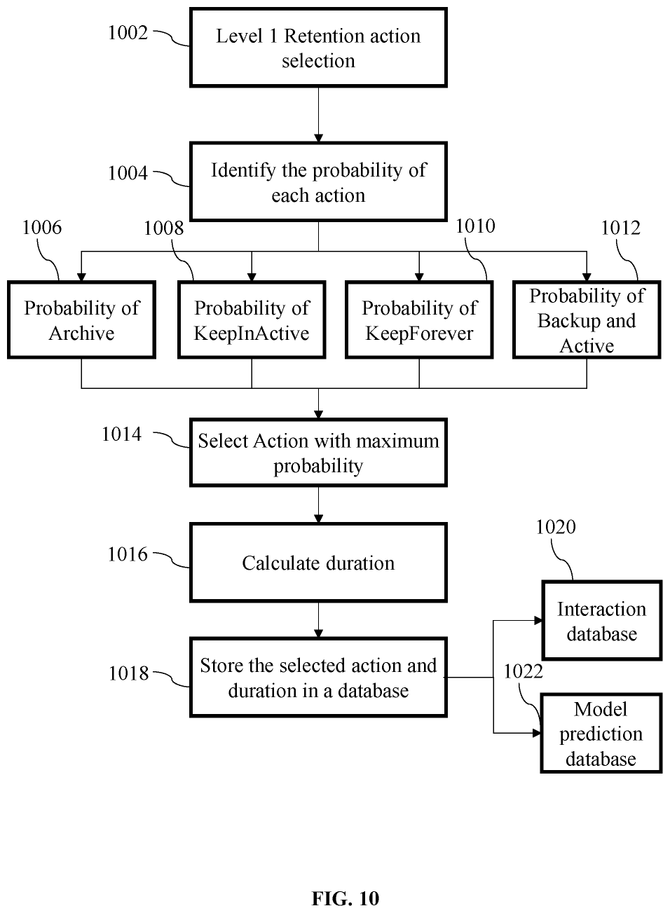

FIG. 10 discloses a flowchart that illustrates a selection of a retention action 1002 as an action category for a rule based on calculated probabilities for four decision categories (operation 1004).

An appropriate storage type for a given interaction may be selected that may be currently kept in active storage “KeepInActive”.

In this example, an action category may be selected based on the probabilities of four available decision categories “archive” (1006), “keepinactive” (1008), keepforever” (1010) and “backup and archive” (1012) as shown in table 13. In case of a single-level decision, only one action category out of the for decision categories can be applied as a rule for example interaction transcript T (1014).

TABLE 13

| # | Available choices: |
|---|---|
| 1 | Archive |
| 2 | KeepInActive |
| 3 | KeepForever |
| 4 | Backup and Archive |

A one-vs-rest (OvR) model with logistic regression can be used to identify the best suitable action category by calculating probabilities for the decision categories using decision parameters. The decision category with the highest probability may be selected as the action category.

For example, probabilities for decision categories may have values P as present in table 14.

TABLE 14

P_{Archive} = 0.5
P_{KeepInArchive} = 0.3
P_{KeepForever} = 0.1
P_{BackupArchive} = 0.1

For the action category “archive” the highest probability may have been calculated and may be selected as an action category, as shown in example formula 15.

$$SelectedAction = Max ( Probabilities of each action ) = Max ( 0.5 , 0.3 , 0.1 , 0.1 ) = Archive \qquad Formula 15$$

For the selected action category “archive”, a period may be calculated after which the selection action category “archive” may be performed (Perform action after days). (operation 1016) A selected action may be performed after a calculated period of time may have expired.

For example, a calculated value “maximum retention days” may be a value provided by a user based on how long maximum a user may desires to retain an interactions in an archive, e.g. 365 days and may be calculated, e.g. using example formula 16.

$$PerformActionAfterDays\_Retention ( days ) = ( Probability value of KeepInActive \times Maximum retention days ) + previousAction\_retion \_period \qquad Formula 16$$

In the present example, a value for a maximum retention days may be set as 120 days.

$$PerformActionAfterDays\_Retention = ( 0.3 \times 120 ) + 0 = 36 days \qquad Formula 17$$

Once a suitable action is chosen, for instance, ‘Archive’, and the timeframe for this action is determined, e.g. using example formula 17 to calculate a timeframe of 36 days, an initial stage of the dynamic lifecycle rule may be worded as “Archive after 36 days.” This implies that the interaction can be kept in the default Active storage (KeepInActive) for 36 days, after which it may be moved to archive storage.

Generated rules and selected action categories for rules for an interaction transcript may be stored in a database (operation 1018), e.g. an interaction database 1020 or a model prediction database 1022.

If single action is selected, like Archiving, is selected, the interaction may be stored in the Archive for an unlimited period of time, unless the user decides to take retrospective action or follow the recommendations of the Dynamic Interaction Module.

When multi-level actions are chosen, the interaction may qualify for additional steps such as Deletion or Copying, as part of its lifecycle management.

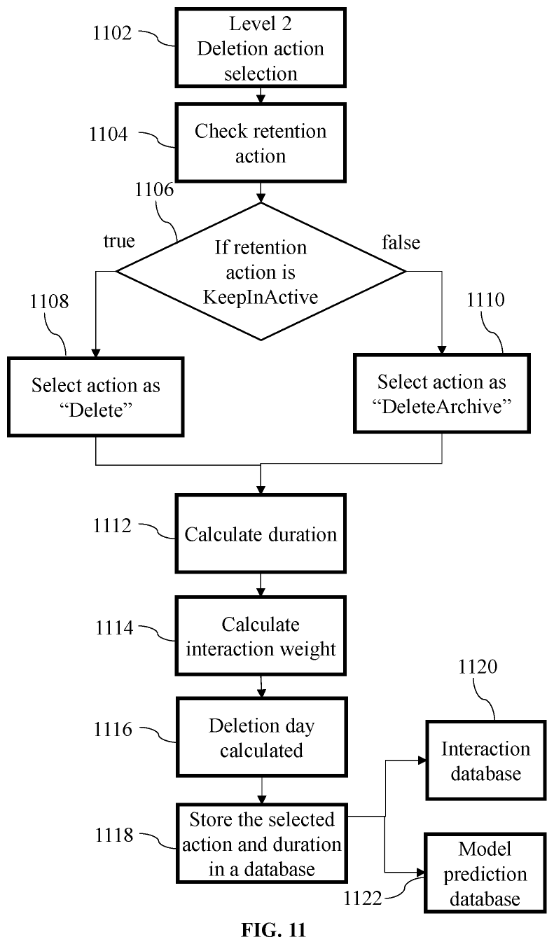

FIG. 11 discloses a flowchart that illustrates a selection of a deletion action 1102 as an action category for a rule based on calculated probabilities for two decision categories (operation 1104), according some embodiments.

An appropriate deletion action may be selected for a given interaction. For example, a deletion action may be selected in a multi-level selection in addition to a retention action such as a retention action “keepinactive” (1106).

A “delete” action (1108) may be applicable, e.g. in case that a keepinactive rule presently applies to an interaction, whereas a “deletearchive” action (1110) may be applicable, e.g. in case that an archive rule presently applies to an interaction. A selection of available deletion actions may be shown in table 15.

TABLE 15

| # | Available choices: |
|---|---|
| 1 | Delete |
| 2 | DeleteArchive |

In operation 1106, a deletion action is selected, e.g. for the case that R=selected retention action as shown in example formula 18.

$$DeletionAction = \{ \begin{matrix}Delete if , R = KeepInActive \\ DeleteArchive if , R = Archive \\ DeleteArchive if , R = BackupArchive \\ otherwise\end{matrix} \qquad Formula 18$$

In operation 1112, a deletion duration may be calculated for a selected deletion action category for a rule.

In the calculation of a deletion duration, e.g. decision parameters that provide information on the importance of an interaction may be identified in an interaction transcript for which a deletion duration is to be calculated.

For example, the importance of an interaction can be quantified and expressed as decision parameters using the following decision parameters:

Customer Importance (CI): The importance of the customer, which could be based on factors like customer lifetime value, loyalty status, or recent purchase history.

Interaction Urgency (IU): The urgency of the interaction, determined by the nature of the query, issue criticality, or response deadlines.

Content Sensitivity (CS): The sensitivity of the information discussed during the interaction, such as personal data, financial details, or confidential information.

Feedback Score (FS): The direct feedback or satisfaction score provided by the customer regarding the interaction.

Each of these factors may be normalized, e.g. to refer to values on a scale between 0 to 1. In the calculation of a deletion day 1116 for an interaction, a calculation interaction weight for an interaction 1114 transcript may be calculated. Example formula 19 can be used in the calculation of an interaction weight, e.g. for decision parameters CI, IU, CS and FS:

$$InteractionWeight = w 1 \times CI + w 2 \times IU + w 3 \times CS + w 4 \times FS \qquad Formula 19$$

$$where , w 1 , w 2 , w 3 , w 4 are the weights assigned to each factor$$

Once an interaction weight is identified, values for maximum retention days and minimum retention days may be set automatically or manually, e.g. by a user. Example formula 20 may be used in the calculation of deletion days 1116, e.g. by calculating a product of an interaction weight and the difference between the maximum number of retention days and the minimum number of retention days:

$$Deletion Days = InteractionWeight \times ( Max RetenDays - Min RetenDays ) + Min RetenDays \qquad Formula 20$$

Assuming the following values for interactionweight, MaxRetenDays and MinRetenDays, a number of deletion days for an interaction transcript can be calculated as shown in example formula 21:
InteractionWeight=0.6,
MaxRetenDays=120,
MinRetenDays=90

$$Deletion Days = 0.6 \times ( 120 - 90 ) + 90 = 108 days \qquad Formula 21$$

An interaction may be deleted after 108 days from last action performed, i.e., when an interaction was archived it may be deleted 108 days after the archival date.

Generated rules and selected action categories for rules for an interaction transcript may be stored in a database 1118, e.g. an interaction database 1120 or a model prediction database 1122.

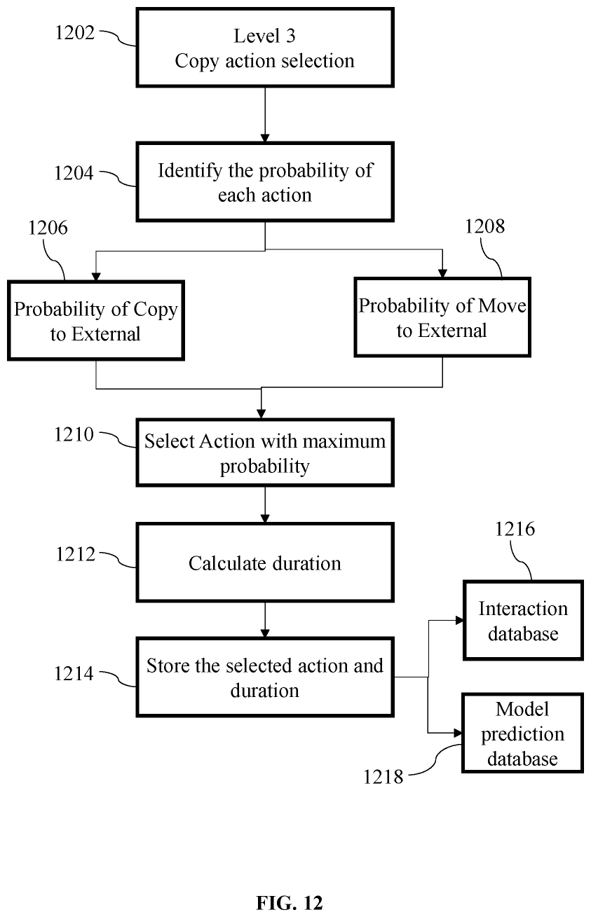

FIG. 12 discloses a flowchart that illustrates a selection of a copy action (1202) as an action category for a rule based on calculated probabilities for two decision categories (1204).

A copy action may be selected, for example, from one of the two options “CopyToExternal” (1206) and “MoveToExternal” (1208) shown in table 16.

TABLE 16

| # | Available choices: |
|---|---|
| 1 | CopyToExternalStorage |
| 2 | MoveToExternalStorage |

Probabilities for decision categories are calculated. For example probability values for decision categories CopyToExternalStorage and MoveToExternalStorage may be calculated as 0.8 and 0.2:
P(CopyToExternalStorage|Context)=0.8
P(MoveToExternalStorage| Context)=0.2

In operation 1210, based on the calculated probabilities, an action with the highest probability may be selected as shown in example formula 22.

$$SelectedAction = Max ( Probabilites of each action ) = Max ( 0.8 , 0.2 ) = CopyToExternalStorage \qquad Formula 22$$

In operation 1212, a duration in days may be calculated. As the action of Copying to External Storage is compatible with all other actions, it can be executed immediately after the interaction becomes available. Therefore, the duration for the Copy action may be set to 0 days.

An action of moving to external storage may include both copying the interaction to a new location and deleting it from the original storage. This can require calculating a duration needed for deletion (confer e.g. example formula 23), as a move action may use this deletion time combined with the time necessary to copy the interaction.

$$Duration for move = DurationNeededToCopy + DeletionDuration \qquad Formula 23$$

Generated rules and selected action categories for rules for an interaction transcript may be stored in a database 1214, e.g. in an interaction database 1216 or a model prediction database 1218.

Table 17 includes example classifications of interactions transcripts between action-decision categories. The result of this process is the identification of relevant actions. Depending on the permissible combinations outlined above, this could be either a single action or a range of multiple actions. By employing a OvR model, appropriate actions may be determined dynamically based on various factors related to interaction management.

TABLE 17

| # | Combinations |
|---|---|
| 1 | Retention only |
| 2 | Deletion only |
| 3 | Copy only |
| 4 | Retain and delete |
| 5 | Copy and retain |
| 6 | Copy and delete |
| 7 | Copy, retain and delete |

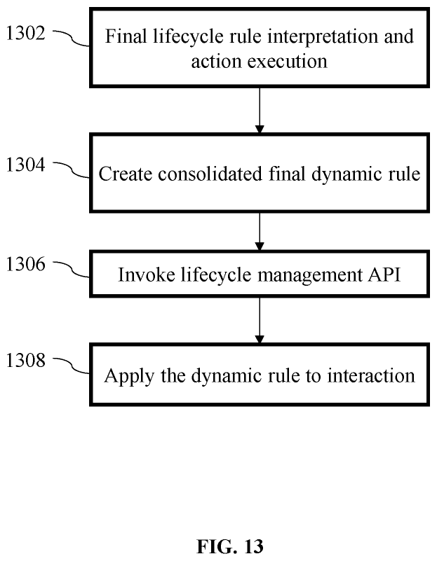

FIG. 13 discloses a flowchart that illustrates operations in the application of a rule for an interaction, according to some embodiments.

In operation 1302, a final lifecycle rule interpretation and action execution may be initiated, e.g. by a storage action selection application 610. For example, application 610 may determine action categories for calculated probabilities for available decision categories and may select action categories via a multi-level selection or single-level selection.

In operation 1304, a consolidated dynamic rule may be created for an interaction transcript, e.g. by dynamic interaction management 608. For example, a rule for managing an interaction transcript may be generated by combining selected action categories and, for example, creating a sequence of selected actions such as a sequence of retention, copy and deletion actions as shown in steps 720, 722 and 724 of FIG. 7.

In operation 1306, a lifecycle management application, e.g. application 630, may retrieve rules for managing an interaction transcript, e.g from a dynamic interaction management application 608.

In operation 1308, a rule for an interaction may be applied to an interaction transcript, e.g. application 630 may execute a copy action for interaction X after a retention time of 30 days.

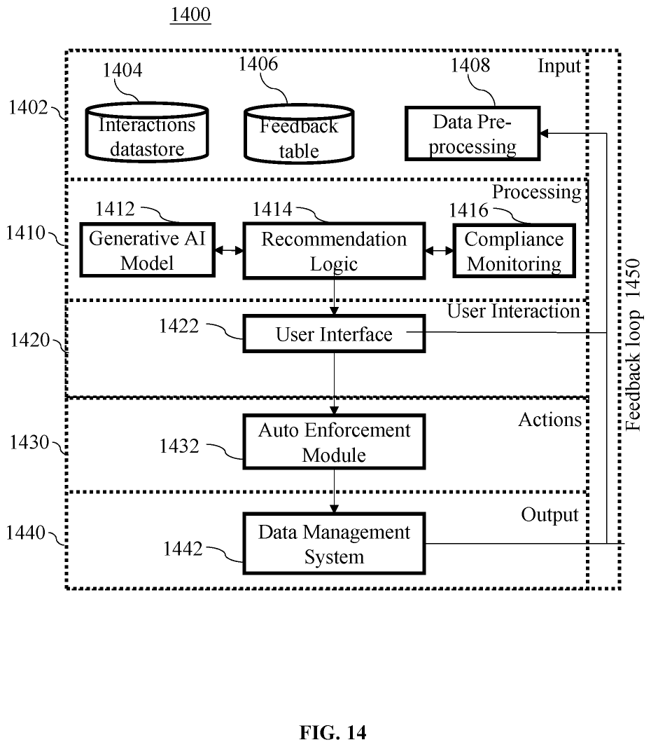

FIG. 14 discloses a diagram 1400 that illustrates operations in the processing of interaction transcripts in the selection of rules for managing such interaction transcripts, for example via recommendation and continuous feedback module 612 executed, e.g. using computing device 100.

Inputs section 1402 includes interaction data store 1404, feedback table 1406 and data pre-processing module 1408.

Interactions data store 1404 may be a module that collects and stores decision parameters, e.g. interaction metadata. It can include transcripts/records of previously received interaction transcripts of a customer, e.g. interaction transcripts such as phone call, text chat or video call transcripts.

Feedback table 1406 may be a database or storage for user or agent feedback on interactions, system usability, or recommendations.

Data preprocessing module 1408 may be a module that can be used in identifying decision parameters in an interaction transcripts or processing such identified decision parameters, e.g. by normalization or encoding them into a numerical format. For example, the module may be used in transforming raw interaction data into a format suitable for analysis and processing by an AI model.

In processing section 1410, machine learning, e.g. a generative AI model such as model 1412, may be used to process identified decision parameters, e.g. pre-processed decision parameters, to determine at least one decision category for an interaction transcript and to calculate probabilities for the at least one decision category for a rule using one or more decision parameters.

A recommendation logic 1414 may retrieve output from a generative AI model, e.g. in form of decision categories and related probabilities, and may select one or more action categories for an interaction for a rule for an interaction transcript based on calculated probabilities for at least one decision category.

Compliance monitoring module 1416 may be used in reviewing compliance of rules for interaction transcripts, e.g. recommendations for managing an interactions with relevant regulations and policies.

AI model module 1412, recommendation logic 1414 and compliance monitoring 1416 may exchange data in a bidirectional flow.

User interaction 1420 may be retrieved, e.g. via user interface 1422. User interface 1422 may be a front-end interface through which users (contact center agents or managers) interact with the system. It may include recommendations and can collect user inputs or adjustments.

Actions module 1430 can manage interaction transcripts based on applying rules that include selected one or more action categories for an interaction, may be automatically applied, e.g. by auto enforcement module 1432. For example, based on the user's settings and preferences, auto enforcement module 1432 can automatically implement the recommended actions without further user intervention. Applying a rule may include executing the action of the rule.

In an output operation 1440, a data management system 1442 may carry out the management of data of interaction transcripts. For example, system 1442 may apply a rule for an interaction transcript such as archiving, deleting or copying an interaction based on generated rule for an interaction transcript.

Feedback loop 1450 may be a module that connects user input, e.g. via user interface 604, and the management of interaction transcripts, e.g. by data management system 1442, and may be used to improve a generative AI Model 1412 based on reviewing the management of interaction transcripts and user input, e.g. via user interface 1422 in the generation of rules for managing interaction transcripts. For example, feedback loop 1450 may be used to improve a generative AI model, e.g. the identification of decision parameters within an interaction transcript, the determination of decision categories, and/or the selection of action categories.

### Example Simulation:

Operation 1: One or more decision parameters in an interaction transcript may be identified, e.g. by extracting context variables from incoming interaction metadata and data normalization. Table 18 shows examples of decision parameters which have been identified in an interaction transcript.

TABLE 18

| # | Interaction management factors | Example Value | |
|---|---|---|---|
| 1 | Agent | Agent123 | |
| 2 | Team | T5 | |
| 3 | Skill | Skill_7 | |
| 4 | Dnis | 789090 | |
| 5 | Ani | +1-800 | |
| 6 | Campaign | C890 | |
| 7 | Region | America | |
| 8 | Customer Type | New | |
| 9 | Interaction Type | Call | |
| 10 | Sentiment Score | −0.2 | |
| 11 | Interaction Sensitivity | High | |
| 12 | Historical Interactions | 3 | |
| 13 | Customer Segmentation | Premium | |
| 14 | Call Duration | 5 | minutes |
| 15 | Customer satisfaction score | 8 | |
| 16 | Date and Time | Jan. 1, 2023 14:30 | |
| 17 | File size | 3 | MB |

| | | |
|---|---|---|
| 18 | Call Outcome | Successful |
| 19 | Language | English |
| 20 | Call Type | Inbound |
| 21 | Location of Caller | New York |
| 22 | Priority Level | High |
| 23 | Seasonality | Summer |
| 24 | Marketing Campaigns | M123 |

### Operation 2: Determining Decision Categories:

At least one decision category for a rule may be determined from the one or more decision parameters for an interaction transcript. There can be more than one category which may get selected based on a pre-set threshold for calculated probabilities for the decision categories. Table 19 illustrates an example set of available categories including retention, deletion and copy categories.

TABLE 19

| # | Available categories |
|---|---|
| 1 | Retention |
| 2 | Deletion |
| 3 | Copy |

Input

```
Input for this step is a set of normalized interaction management factors.
{
  Agent: “Agent123”,
  Team: “T5”
  Skill: “Skill_7”
  Dnis: “1-800”
  .............
}
```

### Processing Steps

### Step 1: Category of Decisions for Prediction

### [Retention, Deletion, Copy]

Step 2: Identify the probabilities for decision actions
1. P(Retention Decision|Context)=0.5
2. P(Deletion Decision|Context)=0.3
3. P(Copy Decision|Context)=0.2

### Step 3: Identify the Category Based on Probability

1. For multi level decisions, consider Threshold to select more than 1 category
2. For single decision: Select the category with highest probability

Outputs

```
For multi-level decision (selected for next step)
{
  ″Type″: ″multi-level″,
  ″SelectedCategories″: [″Retention″, ″Deletion″, ″Copy″]
}
For single level decision
{
  “Type”: “Single-level”,
  “SelectedCategories”: [“Retention”]
}
```

### Operation 3: Perform Level 1 Storage Decision (Retention)

In operation 3, a rule for the selection of an appropriate storage type for an interaction transcript may be selected. By default, interaction may be kept in the active storage. Table 20 may include available choices for storage action categories for an interaction transcript.

TABLE 20

| # | Available choices: |
|---|---|
| 1 | Archive |
| 2 | KeepInActive |
| 3 | KeepForever |
| 4 | Backup and Archive |

Input

```
Input for this step is a set of normalized context variables
and output from previous step.
{
  Agent: “Agent123”,
  Team: “T5”
  Skill: “Skill_7”
  Dnis: “1-800”
  .............
}
```

### Processing Steps

### Step 1: Category of Decisions for Prediction

[Archive, KeepInActive, KeepForever, Backup and archive]

### Step 2: Identify the Probabilities for Decision Actions

1. P(Archive|Context)=0.5
2. P(KeepInActive Decision| Context)=0.3
3. P(KeepForever|Context)=0.1
4. P(BackupArchive|Context)=0.1
   Step 3: Select the Action with Highest Probability

$$\begin{matrix}SelectedAction = Max ( Probabilites of each actions ) \\ = Max ( 0.5 , 0.3 , 0.1 , 0.1 ) \\ = Archive\end{matrix}$$

Step 4: Identify a period after which an action may be performed (maximum retention period 120)
PerformActionAfterDays_Retention (days)=
(Probability value of KeepInActive×Maximum retention days)+
previousAction_retion_period
PerformActionAfterDays_Retention=(0.3×120)+0=36 days

Output

```
The output of previous step may be appended with the current output.
{
  “Type”: “multi-level”,
  “SelectedCategories”: [“Retention”, “Deletion”, “Copy”],
  “SelectedRetentionAction”: {
    “Action”: “Archive”,
    “Period”: “36 days”
    }
}
```

### Interpretation and Rule Formulation:

“Archive after 36 days”

After this operation, the interaction transcript may be kept in storage for 36 days and may then be moved to archival storage.

### Operation 3: Perform Level 2 Storage Decision (Deletion)

In operation 3, an appropriate deletion action with a retention period may be selected. Table 21 includes available choices for deletion action categories for an interaction transcript.

TABLE 21

| # | Available choices: |
|---|---|
| 1 | Delete |
| 2 | DeleteArchive |

Input

```
Input for this step is a set of normalized context variables
and output from previous step.
{
  Agent: “Agent123”,
  Team: “T5”
  Skill: “Skill_7”,
  Dnis: “1-800”
  .............
}
```

### Processing

### Step 1: Category of Decisions for Prediction

[Delete, DeleteArchive]

### Step 2: Identify the Decision Actions

Here, the Delete action is applicable only when the Retention decision is KeepInActive, whereas DeleteArchive action applicable only for Retention decision as Archive

Step 3: Deletion Action Selection, where R=SelectedRetentionAction

$$DeletionAction = \{ \begin{matrix}Delete if , R = KeepInActive \\ DeleteArchive if , R = Archive \\ DeleteArchive if , R = BackupArchive \\ otherwise\end{matrix}$$

In current scenario DeletionAction=DeleteArchive

### Step 4: Identify the Deletion Duration in Days Based on the Interaction Weight.

InteractionWeight=0.6,
MaxRetenDaye=120,
MinRetenDays=90
Deletion Days=InteractionWeight×(MaxRetenDays-MinRetenDays)+MinRetenDays
Deletion Days=0.6×(120−90)+90=108 days

Output

```
The output of previous step may be appended with the current output:
{
  “Type”: “multi-level”,
  “SelectedCategories”: [“Retention”, “Deletion”, “Copy”],
  “SelectedRetentionAction”:
    “Action”: “Archive”,
    “Period”: “36 days”
    },
  “SelectedDeletionAction”:
    “Action”: “DeleteArchive”,
    “Period”: “108 days”
  }
}
```

### Interpretation and Rule Formulation:

“Archive after 36 days then DeleteArchive after 108 days”.

Following this operation, an interaction transcript may be kept in storage for 72 days and may be moved to archival storage and may be deleted after 108 days of storing in archival storage.

### Operation 3: Perform Level 3 Storage Decision (Copy)

In this operation, appropriate copy action decisions for an interaction transcript may be selected. Table 22 includes available choices for copy action categories for an interaction transcript.

TABLE 22

| # | Available choices: |
|---|---|
| 1 | CopyToExternalStorage |
| 2 | MoveToExternalStorage |

Input

```
Input for this step is a set of normalized context variables
and output from the previous step.
{
  Agent: “Agent123”,
  Team: “T5”
  Skill: “Skill_7”,
  Dnis: “1-800”
  .............
}
```

### Processing

### Step 1: Category of Decisions for Prediction

[CopyToExternalStorage, MoveToExternalStorage]

### Step 2: Identify the Probabilities for Decision Actions

1. P(CopyToExternalStorage| Context)=0.8
2. P(MoveToExternalStorage Decision|Context)=0.2
   Step 3: Select the Action with Highest Probability

$$\begin{matrix}SelectedAction = Max ( Probabilites of each action ) \\ = Max ( 0.8 , 0.2 ) \\ = CopyToExternalStorage\end{matrix}$$

### Step 4: Identify the Retention Duration in Days

Output

```
The output of previous step may be appended with the current output:
{
  “Type”: “multi-level”,
  “SelectedCategories”: [“Retention”, “Deletion”, “Copy”],
  “SelectedRetentionAction”: {
    “Action”: “Archive”,
    “Period”: “36 days”
    },
  “SelectedDeletionAction”: {
    “Action”: “DeleteArchive”,
    “Period”: “108 days”
  },
  “SelectedCopyAction”: {
    “Action”: “CopyToExternalStorage”,
    “Period”: “0 days”
  }
}
```

### Interpretation and Rule Formulation:

“Copy after 0 days then Archive after 36 days then DeleteArchive after 108 days” Following this operation, an interaction transcript may be kept in standard storage for 36 days and may be moved to archival storage and deleted after 108 days of storing in archival storage. An interaction transcript may also be copied to secure external access after 0 days.

FIG. 15 depicts an example user interface 1500 for managing interaction transcripts based on dynamic rules.

Interface 1500 may include an overview of lifecycle actions 1510. This section may display statistics related to the number of created dynamic rules for interaction transcripts (1512) or the frequency of interactions with various actions (1514).

Section notifications 1520 may include viewing notifications and automated recommendations for managing interaction transcripts, e.g. this section may display notifications suggesting interactions that are eligible for archiving (1522). This section may include notifications and automated suggestions for rule-based actions, e.g. a deletion warning of interaction transcripts (1524) or a status of the archiving of interaction transcripts (1526).

Interaction Management Interface (1530) may allow users, e.g. a user using user device 602, to send queries to the system, e.g. to initiate the rule-based managing of interaction transcripts, e.g. to execute action categories or to access information such as decision parameters from interaction recordings. For example, a question by a user such as “How many interactions are currently archived that are handled by agent Mark Turner?” (1532) may provide a user within an answer “650 interactions are currently handled by agent Mark Turner” (1534).

Interface 1500 may further include a section that may allow automatic implementation of rules for retrieved interaction recordings (1540), e.g. to automatically execute action categories for interaction transcripts without manual intervention.

Interface 1500 may allow users activating/deactivating automated managing of interaction transcripts (1540), activating/deactivating multi-level selections (1550) or setting threshold values for multi-level selections (1560).

The aforementioned flowcharts and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “1system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

What is claimed is:

1. A method of managing interaction transcripts based on rules, the method comprising:
identifying one or more decision parameters in an interaction transcript;
determining at least one decision category for a rule from the one or more decision parameters;
calculating probabilities for the at least one decision category for the rule using the one or more decision parameters; and
applying the rule by selecting one or more action categories for the interaction transcript based on the calculated probabilities for the at least one decision category.

2. A method according to claim 1, wherein when the selection of the one or more action categories is based on a single-level selection, the rule is based on the decision category with the highest probability.

3. A method according to claim 1, wherein when the selection of the one or more action categories is based on a multi-level selection, the rule is based on the at least one decision category whose calculated probabilities lie above a pre-set threshold value.

4. A method according to claim 1, wherein the identified one or more decision parameters are normalized.

5. A method according to claim 1, comprising encoding the identified one or more decision parameters into a numerical format.

6. A method according to claim 1, wherein the one or more action categories are selected from one or more of: a retention decision, a deletion decision, a copy decision or a combination thereof.

7. A method according to claim 1, wherein when the selected action category is a retention action, calculating a retention period and storing the interaction transcript for the retention period.

8. A method according to claim 1, wherein when the selected action category is a deletion action, calculating a deletion period and storing the interaction transcript until expiry of the deletion period.

9. A method according to claim 1, wherein when the selected action category is a copy action, calculating a copy period and copying the interaction transcript after expiry of the copy period.

10. A method according to claim 1, wherein the one or more decision parameters are converted into binary vectors.

11. A method according to claim 1, wherein applying the rule comprises automatically generating rule recommendations using machine learning for managing the interaction transcript.

12. A method according to claim 11, wherein the generated rule recommendations for managing the interaction transcript are automatically applied to the interaction transcript.

13. A method according to claim 1, wherein the selected one or more action categories within the applied rule are periodically updated using machine learning.

14. A system for managing interaction transcripts based on rules, the system comprising:
a computing device;
a memory; and
a processor, the processor configured to:
identify one or more decision parameters in an interaction transcript;
determine at least one decision category for a rule from the one or more decision parameters;
calculate probabilities for the at least one decision category for the rule using the one or more decision parameters; and
apply the rule by selecting one or more action categories for the interaction transcript based on the calculated probabilities for the at least one decision category.

15. A system according to claim 14, wherein when the selection of the one or more action categories is based on a single-level selection, the rule is based on the decision category with the highest probability.

16. A system according to claim 14, wherein when the selection of the one or more action categories is based on a multi-level selection, the rule is based on the at least one decision category whose calculated probabilities lie above a pre-set threshold value.

17. A system according to claim 14, wherein the identified one or more decision parameters are normalized.

18. A system according to claim 14, comprising encoding the identified one or more decision parameters into a numerical format.

19. A method according to claim 14, wherein the one or more action categories are selected from one or more of: a retention decision, a deletion decision, a copy decision or a combination thereof.

20. A method of selecting rules for handling interaction recordings, the method comprising:
identifying one or more interaction metadata items in an interaction recording;
determining one or more decision categories for a rule from the one or more interaction metadata items;
calculating probability values for the one or more decision categories using the one or more interaction metadata items; and
applying the rule by selecting one or more handling categories for the interaction recording based on the calculated probability values for the one or more decision categories.
